(19) United States
(12) Patent Application Publication
(10) Pub. No.: US 2021/0233186 A1
(43) Pub. Date: Jul. 29, 2021

(54) METHOD FOR MONITORING PROCESSES AND PROGRESS AT A CONSTRUCTION SITE

(71) Applicant: Versatile, Inc., San Francisco, CA (US)

(72) Inventors: Barak Cohen, San Francisco, CA (US); Meirav Oren, San Francisco, CA (US); Danny Hermann, San Francisco, CA (US); Ran Oren, San Francisco, CA (US)

(21) Appl. No.: 17/163,182

(22) Filed: Jan. 29, 2021

Related U.S. Application Data
(60) Provisional application No. 62/967,575, filed on Jan. 29, 2020.

(51) Int. Cl. G06Q 50/08; G06Q 10/06

(52) U.S. Cl. CPC G06Q 50/08; G06Q 10/06316; G06Q 10/0639; G06Q 10/0633; G06Q 10/06311

(57) ABSTRACT

One variation of a method for monitoring processes and progress at a construction site includes: accessing spatial and temporal representations of a sequence of construction tasks planned on the construction site; accessing a first set of load characteristics derived from data captured by a smart hook, arranged on a crane operated at the construction site, and a drop-off location of the smart hook during a first lift event at the crane; correlating the first lift event with a first construction task, in the sequence of construction tasks, based on the first set of load characteristics and the drop-off location; identifying a first notification trigger, in a set of notification triggers linked to the sequence of construction tasks, assigned to the first construction task; and transmitting a first notification to a computing device, associated with a user, according to the first notification trigger, the first notification identifying the first construction task.

### CROSS-REFERENCE TO RELATED APPLICATIONS

This application claims the benefit of U.S. Provisional Application No. 62/967,575, filed on 29 Jan. 2020, which is incorporated in its entirety by this reference.

### TECHNICAL FIELD

This invention relates generally to the field of construction management and more specifically to a new and useful method for monitoring processes and progress at a construction site in the field of construction management.

### BRIEF DESCRIPTION OF THE FIGURES

FIG. 1 is a flowchart representation of a method;

FIG. 2 is a flowchart representation of one variation of the method;

FIG. 3 is a flowchart representation of one variation of the method;

FIG. 4 is a flowchart representation of one variation of the method;

FIGS. 5A and 5B are flowchart representations of one variation of the method; and

FIG. 6 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

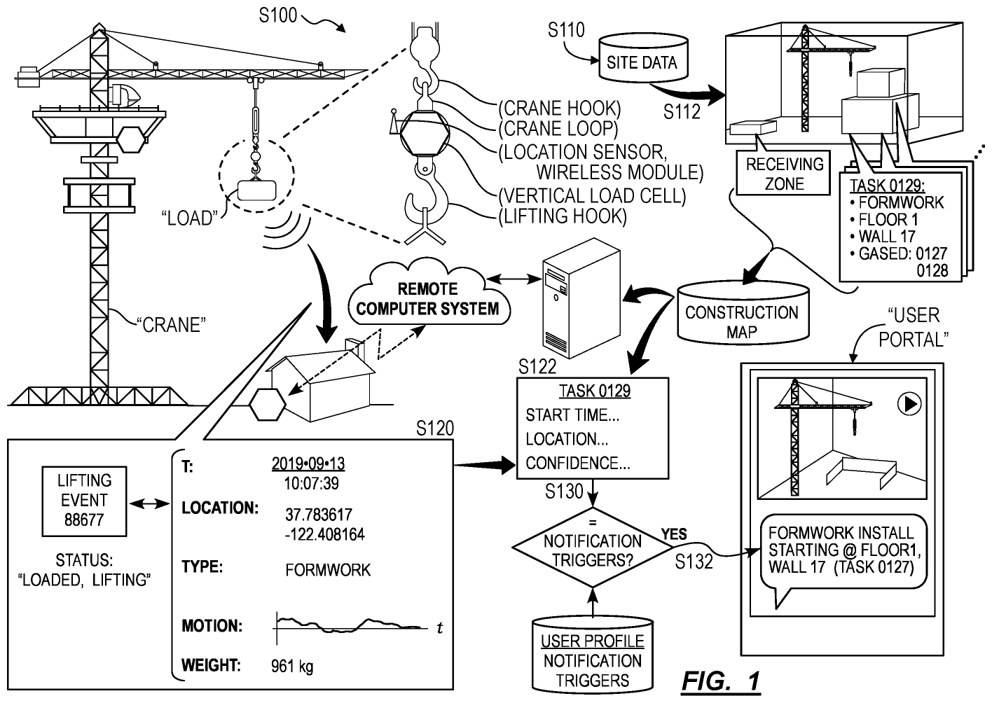

As shown in FIG. 1, a method S100 for monitoring processes and progress at a construction site includes: accessing a building model, a site plan, and a building schedule for the construction site in Block Silo; compiling the building model, the site plan, and the building schedule for the construction site into a construction map containing spatial and temporal representations of construction tasks planned on the construction site in Block S112; accessing a first set of load characteristics detected by a smart hook, arranged on a crane at the construction site, and a first geospatial location of the smart hook during a first lift event at the crane in Block S120; correlating the first lift event with a particular construction task defined in the construction map of the site based on the first set of load characteristics and the first geospatial location in Block S122; querying a set of notification triggers, linked to construction tasks defined in the construction map, for a notification trigger specifying characteristics of the lift event and the particular construction task in Block S130; and, in response to identifying the notification trigger, transmitting a notification to a user portal associated with an author of the notification trigger in Block S132.

One variation of the method S100 includes: accessing a building model, a site plan, and a building schedule for the construction site in Block Silo; compiling the building model, the construction site plan, and the building schedule for the construction site into spatial and temporal representations of a sequence of construction tasks planned on the construction site in Block S112; accessing a first set of load characteristics derived from data captured by a smart hook, arranged on a crane operated at the construction site, and a drop-off location of the smart hook during a first lift event at the crane in Block S120; correlating the first lift event with a first construction task, in the sequence of construction tasks, based on the first set of load characteristics and the drop-off location in Block S122; querying a set of notification triggers, affiliated with a user and linked to the sequence of construction tasks, for a first notification trigger specifying characteristics of the first construction task in Block S130; and, in response to identifying the first notification trigger, transmitting a first notification to a computing device, associated with the user, according to the first notification trigger in Block S132.

### 2. Applications

Generally, the method S100 can be executed by a computer system: to ingest construction plan data, such as in the form of a building model, a site plan, and/or a building schedule; to transform these construction plan data into a dependencies graph (e.g., an ordered sequence) of construction tasks linked to geospatial locations, materials, material quantities, etc.; and to interface with a user (e.g., a site manager, a supervisor), such as via a user portal, to define “tell me when” notification parameters for selectively triggering push notifications—for particular construction tasks, lift event characteristics, or construction task deviations- to the user's computing device. During construction at the construction site, the computer system can then execute Blocks of the method S100: to access lift event data (e.g., material type, material quantity, pickup location, drop-off location) from a “smart hook” mounted to a crane operating on the construction site; to correlate these lift event data to a particular construction task defined in the construction map; and to scan notification triggers assigned to the construction site for a notification trigger (or multiple notification triggers) that specifies parameters fulfilled by the particular construction task and/or characteristics of the lift event. Responsive to detecting such a notification trigger, the computer system can further execute Blocks of the method S100 to generate a notification for this construction task or lift event and to push this notification to the user's computing device (e.g., a smartphone, a smartwatch, a tablet), such as within seconds or minutes of workers rigging the load onto the smart hook at a pickup location or within seconds or minutes of workers unrigging the load from the smart hook at a drop-off location.

Thus, the computer system can execute Blocks of the method S100: to automatically generate “tell me when” notifications—configured to the particular needs and interests of the user—based on extant construction site data and based on real-time lift event data collected by a smart hook deployed on a crane operated at the construction site; and to transmit these “tell me when” notifications to the user in (near) real-time. Therefore, the computer system can execute Blocks of the method S100 to enable the user to receive consistent, timely, and highly-specific data regarding significant and/or deviant construction tasks and lift events at the construction site without relying on individual workers and staff to manually communicate such information to the user or predict whether such information is relevant to the user.

Furthermore, the computer system can generate a spatial and temporal visualization (e.g., a 3D or 4D animation) of real processes and progress occurring on the construction site based on: start times, conclusion times, and live statuses of construction tasks thus correlated with lift event data received from the smart hook; and the construction map of the construction site. The computer system can then publish this visualization to the user portal, thereby enabling the user to quickly review processes and progress occurring at the construction site over time according to true locations and true relative times of these processes and progress, such as via a smartphone or tablet.

Therefore, the computer system can execute Blocks of the method S100: to transform smart hook data into “tell me when” notifications; to serve these notifications to a user in (near) real-time; to generate a visualization representing longer-term construction tasks occurring at the construction site; and to publish this visualization for the user, thereby both informing the user of particularly significant construction tasks at the construction site and enabling the user to quickly visualize a (full or partial) history of processes and progress at the construction site.

The method S100 is described herein as executed by a computer system, such as a computer network or a remote server, to transform data captured by a “smart hook” deployed on a construction site into “tell me when” notifications and to serve these notifications to a user in (near) real-time. However, Blocks of the method S100 can additionally or alternatively be executed by the smart hook, by a local computer, and/or by a user's personal computing device. Additionally or alternatively, the computer system can transform data captured by other sensors throughout the construction site—such as material tracking sensors, worker location trackers, and/or integrated crane sensors—into “tell me when” notifications and to serve these notifications to a user.

### 3. Site Data

Block S110 of the method S100 recites accessing a building model, a site plan, and a building schedule for the construction site. Generally, in Block S110, the computer system can interface with a user (e.g., a site manager, a supervisor)—such as through a user portal within a native application or within a web browser executing on a computing device—to access a 3D electronic building model (e.g., a Building Information Modeling (or “BIM”) model), an electronic site plan, and/or a building schedule for the construction site.

For example, the 3D electronic building model can define a volumetric representation of a building (or other structure) on the construction site, such as including discrete volumetric representations of: rebar elements; cast-in-place concrete elements; precast elements; structural steel elements; exterior façade elements; wall studs; interior walls surfaces; glazing elements; plumbing elements; electrical and communications elements; and/or HVAC elements; etc.

In this example, the site plan can define a 2D or 3D representation of the construction site, such as including georeferenced perimeters or locations for: the building (or other structure); drive- and walkways; exterior landscaping and lighting elements; material staging zones (e.g., formwork, scaffolding, and rebar storage areas); material receiving zones; material processing areas (e.g., an onsite concrete mixing area); and/or a crane tower location and crane access scope.

Furthermore, in this example, the building schedule can specify: a set of construction tasks (e.g., installing scaffolding; installing rebar; pouring concrete); a set of construction cycles (e.g., construction of a structural elements of a building floor), each containing a set of construction tasks; and/or a target start time, completion time, and/or duration of each construction task or construction cycle.

### 4. Construction Map

Block S112 of the method S100 recites compiling the building model, the site plan, and the building schedule into a construction map containing spatial and temporal representations of construction tasks planned on the construction site. Generally, in Block S112, the computer system can fuse the building model, the site plan, and the building schedule for the construction site into an ordered sequence of construction tasks.

In one implementation, the computer system can fuse these construction data into an ordered sequence of construction tasks, wherein each construction task is associated with: a construction task type (e.g., receiving and staging, material delivery for installation, tool delivery for task support, tool retrieval, and site removal); a material (or tool); a material (or tool) quantity; rigging geolocation on the construction site; an unrigging geolocation at the construction site; a georeferenced building volume for (permanent or temporary) installation of the material (or tool); a target start time, conclusion time, and/or duration of the construction task; a link to a preceding construction task(s) requiring completion and/or inspection prior to the construction task; and/or a link to a subsequent construction task(s) not permitted prior to completion or inspection of the construction task.

For example, the computer system can spatially align the building model to the site plan. The computer system can then: select a first construction task in the construction schedule; initialize a new construction task object for this construction task; read a material (or tool) from this construction task and a location description from the construction task; query the site plan for an unloading geolocation that matches this location description and for a rigging location associate with storage or staging of this material; and then write this material (or tool), this rigging geolocation, and this unloading geolocation to the construction task object. Furthermore, the computer system can: scan the building model for a first (or lowest) discrete volume of this material; write a georeferenced boundary around this discrete volume to the construction task object; and write a start time, conclusion time, and/or duration—extracted from this construction task in the schedule—to this construction task object. The computer system can then repeat this process for each other construction task represented in the schedule. Thus, in this implementation, the computer system can implement present rules for fusing these site data into a set of construction tasks for the construction site.

In another implementation, the computer system implements natural language processing and artificial intelligence to interpret and transform these site data into a set of construction task objects for the construction site.

Additionally or alternatively, the computer system can interface with the user—via the user portal—to manually define links between elements in the building model, the site plan, and the building schedule. In this implementation, the computer system can then compile linked elements from these site data into a set of discrete, ordered, and gated construction tasks for the construction site.

However, the computer system can implement any other method or technique to fuse the site data into a set of construction tasks for the construction site in Block S112. The computer system can then store this set of construction tasks in a computer system for the construction site.

### 5. “Tell Me When” Notification Setup

The computer system can also interface with a user (e.g., a site manager, a supervisor)—via a user portal—to define “tell me when” notification triggers for the construction site. In one implementation, the computer system interfaces with the user to define task-based notification triggers, such as: a notification trigger for a particular construction task; a notification trigger for any instance of a repeated construction task (e.g., formwork installation); a notification trigger for misordered construction tasks; and/or a notification trigger for a particular sequence of construction tasks. For example, the computer system can: present to the user—via the user portal—the ordered set of construction tasks derived in Block S112; prompt the user to select an individual construction task for a notification trigger from this ordered list; and then write an unique identifier of this construction task to the user's profile. In this example, once the user selects a particular construction task, the computer system can also: search the remaining set of construction tasks for identical (or very similar) construction tasks specifying different start and/or conclusion times; prompt the user to confirm similar notification triggers for these other like construction tasks; and then write unique identifiers of these construction tasks to the user's profile. Similarly, the computer system can: prompt the user to select a group or sequence of construction tasks from this ordered set of construction tasks; define a notification trigger for contiguous or non-contiguous instances of these selected construction tasks; and define a notification trigger for disordered instances of these selected construction tasks.

In another implementation, the computer system can interface with the user to define notification triggers specifying characteristics of construction tasks, such as: rigging location; unloading location; material type; and/or material weight. For example, the computer system can compile all unique features across all of these construction tasks for the construction site and present these features to the user via the user portal, such as in the form of: a geospatial map annotated with receiving, staging, and building locations; a dropdown menu of material and tool types; a range of values for material weight; and/or a range of values for construction task start time, conclusion time, and/or duration. The computer system can store features thus selected by the user, filter remaining construction tasks that fulfill these features in real-time, and generate a notification trigger containing these features when confirmed by the user. Thus, in this example, the computer system can store a notification trigger for a particular material (e.g., rebar, scaffolding, or formwork), which defines generation of a notification for the user whenever this material is loaded onto the crane. Additionally or alternatively, in this example, the computer system can store a notification trigger for a particular material (e.g., steel girders; formwork) and a particular rigging or unloading location (e.g., a material receiving location on the construction site; a location of a foundation pier of the building), which defines generation of a notification for the user whenever this material is loaded onto or unloaded from the crane at the particular location (e.g., when steel girders are rigged onto the crane at the material receiving location to indicate arrival of steel girders arrive on-premises; when formwork is unloaded at a foundation wall to indicate readiness for installation of formwork around a rebar assembly).

Similarly, in this example, the computer system can store a notification trigger for an amount of a particular material (e.g., concrete) and a particular rigging or unloading location (e.g., a location of a concrete floor of the building), which defines generation of a notification for the user whenever this amount of this material is loaded onto or unloaded from the crane at the particular location (e.g., when 50% of a concrete weight allocated for a floor of the building is delivered within a geofenced perimeter of the building over a sequence of construction tasks).

Additionally or alternatively, the computer system can interface with the user to define notification triggers specifying types and magnitudes of differences between instances of identical (or similar) construction tasks. For example, the computer system can define a notification trigger that specifies generation of a notification in response to: a minimum difference in duration from a start time of an instance of a first construction task (as indicated by delivery of a first material for this first construction task to the building perimeter) to a start time of an instance of a next construction task; a minimum difference in physical distance between a drop-off location of materials in an instance of a construction task and an average drop-off location of instances of this construction task; or a minimum difference in weight of a material delivered to the building during in an instance of a construction task and an average delivered weight of this material across instances of this construction task.

In another example, the computer system can automatically prompt the user to add additional notification triggers and/or mute (or cancel) existing notification triggers in response to a contextual change on the construction site, such as: detection of a material not previously identified at the construction site; or a change in organization on the construction site (e.g., a 50% increase in quantity of workers detected onsite).

However, the computer system can interface with the user to define notification triggers of any other type and specifying any other construction task features. The computer system can then populate the user's profile with these notification triggers. Furthermore, the computer system can interface with the user to define a delay period (e.g., one hour) between detection of features of a notification trigger and transmission of a corresponding notification to the user.

(The computer system can also interface with various other users to populate their corresponding user profiles with (unique) sets of notification triggers for the construction site, such as a first set of notification triggers for a crane superintendent that differ from a second set of notification triggers for a project manager.)

### 6. Smart Hook

As described above, the computer system can interface with a smart hook—installed on a lift hook of a crane—to receive lift event data as materials and tools are rigged to the crane at pickup locations on the construction site and unloaded from the crane at other drop-off locations on the construction site.

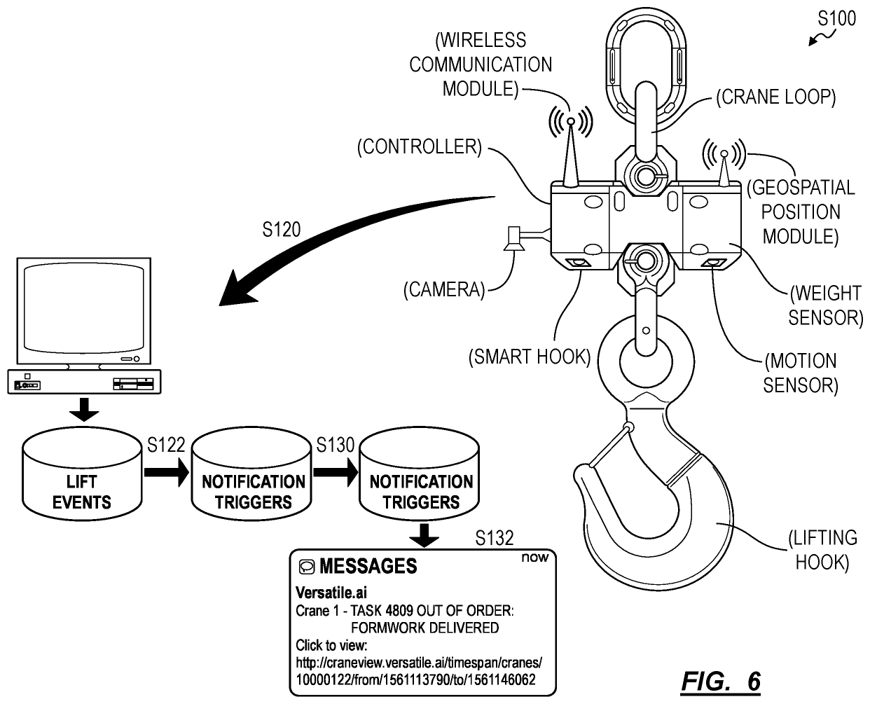

In one implementation shown in FIG. 6, the smart hook (or “hook adapter”) includes: a crane loop (e.g., a “welded link,” “oval ring,” or shackle) configured to transiently (i.e., temporarily, removably) install on a crane hook of a crane; a lifting hook arranged below the crane hook and configured to couple to a load; a weight sensor (e.g., a load cell) interposed between the crane loop and the lifting hook and configured to output a signal representing a tensile force between the crane loop and the lifting hook; a motion sensor (e.g., a gyroscope, accelerometer, magnetometer, and/or IMU) configured to output signals representing accelerations and/or angular velocities of the smart hook; an optical sensor (e.g., a color camera, a depth sensor, a 3D camera, and/or an infrared camera) defining a field of view facing downward below the lifting hook; a geospatial position module configured to output its geospatial location; an altimeter configured to output a signal representative of the height of the smart hook; a controller configured to sample the weight sensor, the motion sensor, the optical sensor, and the geospatial position module and/or to transform these signals into lift event records according to the method S100; and a wireless communication module configured to transmit raw data output by the weight sensor, the motion sensor, the optical sensor, and the geospatial position module and/or to transmit lift event records to a remote computer system. (The smart hook can also include other sensors, such as an RFID reader, a humidity sensor, an infrared camera, an ultrasonic depth sensor, and/or a scanning LIDAR sensor.)

Generally, the smart hook can be rapidly deployed to cranes of various sizes and lifting capacities by placing the crane loop over a crane hook with the lifting hook hanging below the crane loop. A load (e.g., construction materials, construction equipment, scaffolding) may then be attached to the lifting hook, which transfers the weight of the load into the crane loop, which transfers the weight of the load and the smart hook into the crane hook thus carried by the crane. In particular, the smart hook: is configured for rapid deployment to a crane without modification to structural elements of the crane; and includes sensors that enable tracking of load weight, motion, and 3D position (e.g., geospatial location and altitude) directly at the lifting hook carrying the load (i.e., rather than remotely from the load). Furthermore, because the smart hook is self-contained and is configured to install onto and hang below a crane hook integrated into a crane, the smart hook can be rapidly installed and removed from a crane hook by simply lifting the crane loop onto and off of a crane hook. Therefore, the smart hook may follow a general contractor or site manager to various job sites over time in order to supply load-related insights to the general contractor or site manager over time.

Furthermore, the smart hook and/or the computer system can implement template matching, deep learning, and/or artificial intelligence techniques to distinguish different types of objects lifted by the smart hook, such as including: a long steel beam based on a linear increase in load measured by the load cell in the smart hook as the beam is lifted and low-amplitude resonant vibrations between 100 Hz and 1000 Hz measured by a motion sensor (e.g., an IMU, an accelerometer) in the smart hook once the beam is fully lifted; a bundle of loose rebar based on a continuous but non-linear increase in load measured by the load cell as the bundle is lifted and moderate-amplitude resonant vibrations between 0.1 Hz and 5 Hz measured by the motion sensor once the bundle is fully lifted; and a loaded concrete mixer based on high-amplitude oscillations between 0.1 Hz and 2 Hz (i.e., from wet concrete “sloshing” inside a drum in the concrete mixer) and lower-amplitude, higher-frequency machine vibrations (i.e., from a motor rotating the drum) measured by the motion sensor once the concrete mixer is fully lifted. In these examples, the smart hook (or the computer system) can generate a lifting event for each of these loads. For each of these lifting events, the smart hook can also store: a peak weight measured by the load cell during the lifting event; geospatial locations output by the geospatial position sensor when the load was first detected and then unloaded; and altitudes output by an altimeter in the smart hook when the load was first detected and then unloaded. Furthermore, when the concrete mixer is then unloaded, lifted away from the drop-off location, and returned to the pickup location, the smart hook (or the computer system) can record a change in weight of the concrete mixer as an amount of concrete delivered to this drop-off location and write this amount of concrete to the corresponding lifting event record.

### 7. Lift Event Data

Block S120 of the method S100 recites accessing a first set of load characteristics detected by a smart hook, arranged on a crane at the construction site, and a first geospatial location of the smart hook during a first lift event at the crane.

In one implementation, in Block S120, the computer system receives a stream of lift event data from the smart hook. For example, the computer system can receive lift event data from the smart hook at a rate of 1 Hz, including: the geospatial location of the smart hook; a weight of a load connected to the smart hook; images captured by a camera integrated into the smart hook; and/or a material type (and/or confidence scores for various material types) of a load (or “object”)—connected to the smart hook—predicted locally by the smart hook based on these image, motion, and/or load data thus collected by the smart hook. Alternatively, the computer system can: receive raw geolocation, image, motion, and/or load data from the smart hook; and predict a material type of a load rigged to the smart hook during a current lift event based on these data.

### 7.1 Object Models

In one implementation, during operation, the smart hook accesses object models for identifying types of object flowing through the construction site, such as in the form of: weight ranges and loading/unloading profiles (or “template loading curves”) for distinguishing object types in timeseries load data captured by the weight sensor; natural frequency ranges or natural frequency profiles (or “template vibration curves”) for distinguishing object types in timeseries motion data (e.g., acceleration, angular velocity data) captured by the motion sensor; and/or template images, color models, and/or symbol models for identifying object types in images recorded by the optical sensor based on features extracted from these images.

Additionally or alternatively, these object models can specify physical object characteristics (e.g., common dimensions, color) and/or operational knowledge (e.g., rigging methods, unloading and installation methods). The smart hook can thus identify an object carried by the smart hook further based on these object models and other features extracted from images and/or motion data captured by the smart hook during a lift event.

Additionally or alternatively, the smart hook can implement neural networks or other models trained to distinguish types of objects loaded onto the smart hook based on timeseries load data, timeseries motion data, and/or photographic images.

### 7.2 New Lift Event

While in an active state, the smart hook can: sample the weight sensor; convert outputs of the weight sensor into weight magnitudes; and write these timestamped weight magnitudes—along with motion data read from motion sensors, geospatial location data, and altitude—to a local rolling buffer (e.g., a one-minute rolling buffer). When the weight magnitude measured by the weight sensor exceeds a stored tare value by more than a threshold weight (e.g., 50 kilograms), the smart hook can: detect a new lift event at the smart hook; initialize a new lift event record for this new lift event; and write contents of the buffer (e.g., raw sensor data) to the new lift event record. The smart hook can then continue to sample the weight sensor, the motion sensor, the geospatial position module, and the altimeter, etc. (e.g., at the same or greater sampling rates) and write these data to new lift event record.

Upon detecting a new lift event, the smart hook can also transmit a “loading” status to the remote computer system to indicate to the remote computer system that the smart hook is currently being loaded with an object. The remote computer system can then update a status of the smart hook in the manager portal to reflect this new status of the smart hook, thereby enabling the site manager or other operator viewing the manager portal to immediately see a live change in the status of the smart hook.

### 7.3 Object Type Identification

Generally, the smart hook can automatically identify a type of object (and other characteristics of this object) carried by the smart hook based on timeseries data collected by weight sensor and/or the motion sensor, etc. during a lift event. For example, the smart hook can derive a “fingerprint” of a load in each of multiple sensor modalities, predict the identity of the load in this different sensor modalities based on data collected by these sensors, and then fuse these predictions to identify a type of the load with greater confidence, as shown in FIGS. 1, 2, and 3.

### 7.3.1 Loading Profile

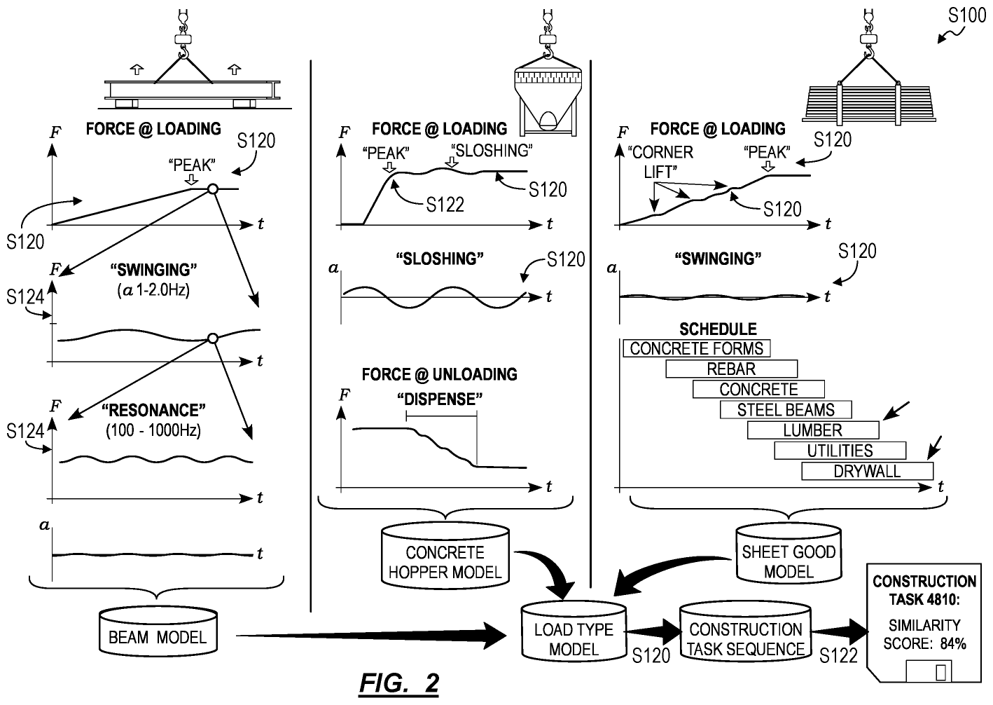

In one implementation shown in FIG. 2, the smart hook:records a timeseries of weight values read from the weight sensor following the start of the new lift event; calculates a derivative of this timeseries of weight values; and isolates a segment of this timeseries exhibiting a null or near-null derivative and corresponding to a “loading period.” The smart hook then extracts a loading profile (e.g., a curve geometry, a rate of change) from the timeseries of weight values recorded over this loading period and matches this loading profile to a template loading profile for a particular object type.

### 7.3.2 Motion Profile

The smart hook can similarly: monitor lateral and vertical timeseries acceleration signals output by a multi-axis accelerometer (e.g., within an inertial measurement unit) in the smart hook; and identify the object based on these timeseries acceleration values. For example, the smart hook can identify a load carried by the smart hook as a concrete hopper in response to detecting a low-frequency, decaying signal component in a signal—output by a horizontal axis in an accelerometer integrated into the smart hook—which may result from concrete sloshing laterally inside the concrete hopper, as shown in FIG. 2.

Additionally or alternatively, the smart hook can similarly: monitor angular velocity signals output by a multi-axis gyroscope (e.g., within the inertial measurement unit) in the smart hook; and identify the object based on these timeseries angular velocity values. For example, because longer objects may angularly accelerate at slower rates than shorter objects of the same mass, the smart hook can: calculate a confidence score that an object carried by the smart hook is an elongated steel beam inversely proportional to a change in yaw rate detected by the multi-axis gyroscope during the lift event; and calculate a confidence score that the object is a stack of sheet materials proportional to this change in yaw rate.

### 7.3.3 Weight

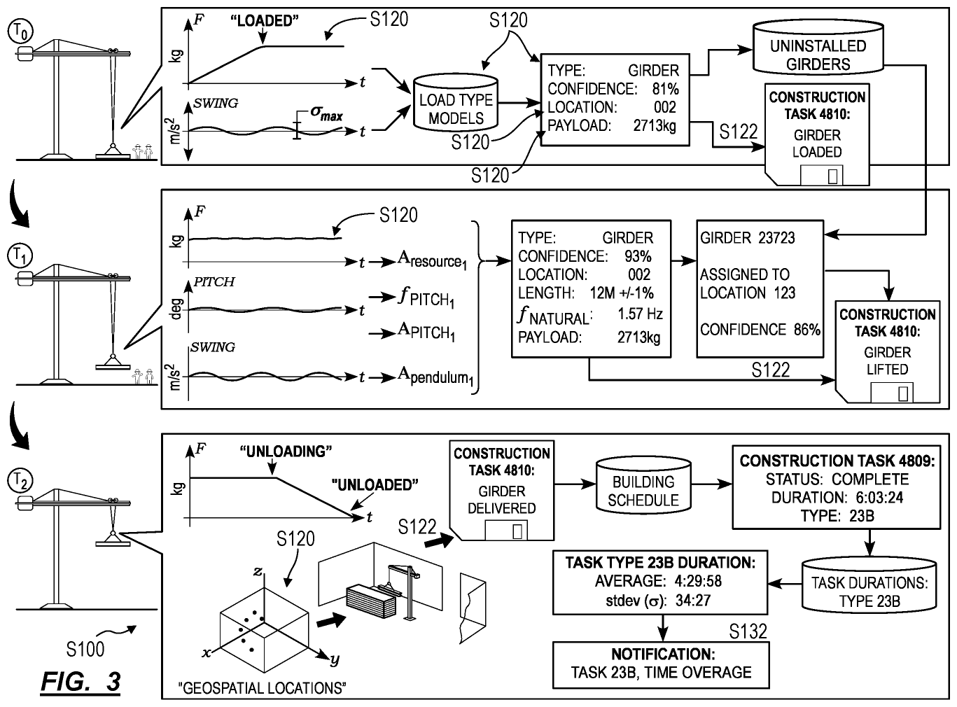

In another implementation shown in FIGS. 2 and 3, the smart hook stores common weight ranges for objects of different types (e.g., full or empty concrete hoppers, steel beams, concrete forms, full stacks of sheet goods, rebar bundles), such as common weight ranges for many construction projects or for the particular construction site currently occupied by the smart hook. The smart hook can then: derive a payload size (or “weight”) of the object from load data captured by the weight sensor in; and calculate a confidence score that an object currently carried by the smart hook is of a particular object type based on proximity of this payload size to a weight range associated with this particular object type.

### 7.3.4 Location

In yet another implementation, the smart hook stores: last known geospatial locations and altitudes of objects of known types at the construction site; geospatial locations and altitudes of staging areas for particular object types at the construction site; and/or geospatial locations and altitudes of drop-off (or “delivery”) locations for particular object types at the construction site, such as a function of date, week, or project stage at the construction site. The smart hook can then calculate a confidence score that an object currently carried by the smart hook is of a particular object type based on proximity of the geospatial location of the smart hook when the object was loaded to a last known location of objects of this type and/or to an assigned staging area of objects of this type. Similarly, as the object is unloaded from the smart hook at the end of a lift event, the smart hook can calculate a confidence score that an object currently carried by the smart hook is of a particular object type based on proximity of the geospatial location of the smart hook when the object was unloaded to a drop-off location assigned to objects of this type.

The smart hook can also calculate or refine a confidence score that an object currently carried by the smart hook is of a particular object type based on proximity of the current time to a scheduled lift event designating this object type.

### 7.3.5 Images

In another implementation, the smart hook implements object detection, object recognition, optical characteristic recognition, template matching, and/or other computer vision techniques to identify the type of object loaded onto the smart hook based on features extracted from an image captured by the optical sensor.

For example, in response to detecting an increase in load—from a tare value—carried by the smart hook, the smart hook can: detect a new lift event; and capture a photographic image from a downward-facing camera integrated into the smart hook. The smart hook can then pass this photographic image into a neural network (e.g., a deep convolutional network for object detection, a fully convolutional network for semantic segmentation) to: extract features from a foreground in the photographic image; and identify the type of the object based on these features. Alternatively, after identifying the type of the object based on loading and motion data captured during this lift event, the smart hook can verify the object type thus identified based on this photographic image (e.g., based on features extracted from the photographic image).

In this implementation, the smart hook can also interpret pitch, roll, and/or yaw orientations of the object—relative to the smart hook—based on features detected in a photographic image. By repeating this process while the object is loaded onto the smart hook, the smart hook can track the pitch, roll, and/or yaw orientations of the object—relative to the smart hook—throughout this lift event in near real-time based directly on visual features extracted from images of the object hanging below the smart hook.

The smart hook can additionally or alternatively include other types of optical sensors. For example, the smart hook can include a thermographic (or infrared) camera and can distinguish between metal (e.g., rebar, steel girders), wood (e.g., formwork), concrete, and other materials of objects loaded onto the smart hook based on thermal signatures extracted from regions of thermographic images depicting these objects carried by the smart hook. In a similar example, the smart hook can include a hyperspectral or multispectral camera and can distinguish between metal, wood, concrete, and other materials of objects loaded onto the smart hook based on spectral signatures extracted from regions of hyperspectral or multispectral images depicting these objects carried by the smart hook.

### 7.3.6 Fusion

The smart hook can then calculate a confidence score that an object currently loaded onto the smart hook is of a particular object type based on data collected by sensors integrated into the smart hook, the smart hook can aggregate these confidence scores for various object types across multiple sensor modalities into one prediction of the type of the object, as shown in FIGS. 1, 2, 3, and 4.

### 7.3.6.1 Voting

In one implementation, the smart hook can implement a voting architecture, decision tree, linear regression, or any other structure to fuse or aggregate predictions for the type of object—based on sensor data of different types—into one predicted identity of the object.

In this implementation shown in FIGS. 2 and 3, the smart hook can: derive a lifting profile—representing transition of the weight of the object onto the smart hook from a first time to a second time spanning a loading period—from a timeseries of load values captured by the smart hook; detect a peak load, in the timeseries of load values, representing complete loading of the object onto the smart hook at the second time; and store this peak load as the weight of the object. The smart hook can then: derive a natural frequency of the object from a second timeseries of load values captured by the smart hook over a traversal period following the second time (i.e., once the object is fully loaded onto the smart hook); and derive a pitch frequency of the object (e.g., a frequency than the object pitches, rolls, or “sloshes” while suspended from the smart hook) from a second timeseries of motion values (and/or from the second timeseries of load values) captured by the smart hook during the traversal period.

The smart hook can then: identify a set of object types allocated to the construction site generally or designated for relocation by the crane during a current work period (e.g., the current day, a current shift); retrieve object profiles for these object types; calculate a set of pitch frequency similarity scores for the object, wherein each pitch frequency similarity score in the set represents proximity of the pitch frequency of the object to a pitch frequency range of an object type in this set of object types; calculate a set of natural frequency similarity scores for the object, wherein each natural frequency similarity score in the set represents proximity of the natural frequency of the object to a natural frequency range of an object type in this set of object types; calculate a set of weight similarity scores for the object, wherein each weight similarity score in the set represents proximity of the weight of the object to a range of weight of an object type in this set of object types; calculate a set of loading similarity scores for the object, wherein each loading similarity score in the set represents proximity of the slope and an oscillation characteristic of the loading profile of the object to ranges of slopes and oscillation characteristics of an object type in this set of object types; and/or calculate a set of pickup location similarity scores for the object, wherein each pickup location similarity score in the set represents proximity of the geospatial location of the smart hook when the object was loaded onto the smart hook to a last known location of an object type, in this set of object types, on the construction site; etc.

The smart hook can then identify the object as a unit of a particular object type based on a combination of the set of pitch frequency similarity scores, the set of natural frequency similarity scores, etc. For example, for a first object in the set of objects allocated to the construction site, the computer system can: calculate a combination (e.g., a linear combination, a weighted combination) of the pitch frequency similarity score, the natural frequency similarity score, the weight similarity score, the loading similarity score, and/or the pickup location similarity score between the object and the first object type; and then store this resulting combination as a confidence score that the object is a unit of the first object type. The smart hook can then repeat this process for each other object type in the set.

Subsequently, the smart hook can identify a particular object type associated with a highest confidence score in this set. If the confidence score for the particular object type exceeds a minimum confidence score, the smart hook can confirm identification of the object as a unit of this particular object type. Conversely, if the confidence score for the particular object type is less than the minimum confidence score, the smart hook can: provisionally identify the object as a unit of this particular object type; mark the object as provisionally identified in subsequent notifications and lift event records generated by the smart hook (or the remote computer system) for this object; and continue to refine and validate identification of the object based on subsequent data captured by the smart hook during this lift event, as described below.

Upon identifying the type of the object, such as with greater than a threshold confidence, the smart hook can transmit an identifier for this object type to the remote computer system, and the remote computer system can update the manager portal to indicate that an object of this type is currently loaded onto the smart hook. The smart hook can also write the identifier of this object type to the current lift event record.

### 7.3.6.2 Artificial Intelligence and Deep Learning

Additionally or alternatively, the smart hook can implement artificial intelligence, machine learning, and/or deep learning techniques: to ingest timeseries load, motion, and/or geospatial location data, etc. recorded as the object is loaded onto and carried by the smart hook; and to output a confidence score or rank for a type of the object carried by the smart hook. The smart hook can then execute methods and techniques described herein based on a highest-confidence object type thus identified during a lift event by the smart hook.

### 7.3.6.3 Examples

Therefore, in one example, the smart hook can: capture a first timeseries of load values output by a weight sensor, coupled to the smart hook, during a first time period; capture a first geospatial location of the smart hook during loading of an object onto the smart hook during the first time period; derive a lifting profile of the object at the first geospatial location from the first timeseries of load values; derive a weight of the object from the first timeseries of load values; and identify a type of the object carried by the smart hook during the first time period based on the lifting profile.

In a similar example, the smart hook can: capture a first timeseries of load values output by a weight sensor, coupled to the smart hook, during a first time period; capture a first timeseries of motion values output by a motion sensor coupled to the smart hook; capture a first geospatial location of the smart hook during the first time period; derive a lifting profile from the first timeseries of load values; derive a first oscillation characteristic from the first timeseries of motion values; and identify a type of an object, carried by the smart hook during the first time period, based on the lifting profile and the first oscillation characteristic. In particular, in this example, the smart hook can: derive a pitch frequency of the object from the first timeseries of motion values; derive a natural frequency of the object from the first timeseries of motion values; calculate a set of pitch frequency similarity scores for the object, each pitch frequency similarity score in the set of pitch frequency similarity scores representing proximity of the pitch frequency of the object to a pitch frequency range of an object type in a set of object types; calculate a set of natural frequency similarity scores for the object, each natural frequency similarity score in the set of natural frequency similarity scores representing proximity of the natural frequency of the object to a natural frequency range of an object type in the set of object types; and identify the object as a unit of a first object type based on a combination of the set of pitch frequency similarity scores and the set of natural frequency similarity scores.

### 7.4 Load Verification and Object Type Refinement

Furthermore, the smart hook can repeat the foregoing methods and techniques to verify or refine the type of object thus identified in based on additional data collected by the smart hook after the object is loaded onto the smart hook and until the object is subsequently unloaded, as shown in FIG. 3. In particular, the smart hook can calculate increasing confidence scores for the identity of the object over time based on additional load, motion, and geospatial location data collected by the smart hook between a time the object is loaded onto the smart hook and a time that the object is unloaded from the smart hook.

In one example, ends of a long beam may be guided manually with rigging or tow lines when lifted at a pickup location and when lowered at a drop-off location. Manipulation of the beam via the rigging lines may yield acyclic vertical loads and acyclic angular velocities about the pitch and yaw axes of the steel beam with long ramp times and decay times. Therefore, if the smart hook detects acyclic load changes and acyclic angular velocities with long ramp times following detection of a payload size during a lift event, the smart hook can calculate a greater confidence that the object is a long beam.

In another example, when a long beam is lowered onto the ground or other structure below, one end of the beam may contact the ground first, thereby transferring some weight from this first end of the beam into the ground. As the length of the beam makes contact with the ground as the beam is further lowered, the weight of the beam carried by the smart hook may decrease continuously (e.g., approximately linearly). The load profile of the signal output by the weight sensor as a beam is unloaded from the smart hook may therefore be characterized by a substantially continuous downward slope from payload size to tare. Conversely, when a stack of sheet goods is lowered onto the ground or other structure, one corner of the stack may contact the ground first, thereby transferring some weight from this first corner of the stack into the ground. As the stack is further lowered, one edge of the stack may come into contact with the ground. As the stack is lowered even further and then fully unloaded from the smart hook, the opposing edge of the stack may come into contact with the ground. The load profile of the signal output by the weight sensor as a stack of sheet goods is unloaded from the smart hook may therefore be characterized by two or more discontinuities or inflections, which may differ from a load profile of a signal output by the weight sensor as a beam is unloaded from the smart hook, which may be characterized by one discontinuity or inflection.

In yet another example, a concrete hopper may be left attached and (partially) supported by the smart hook upon arrival at a drop-off location. Concrete may then be dispensed from the concrete hopper, and the concrete hopper may then be hoisted and moved away from this drop-off location by the smart hook. Therefore, once the concrete hopper is lowered at its drop-off location, the load measured by the weight sensor may decrease (slowly) from an initial payload size but may not reach the stored tare value before the measured load again increases as the concrete hopper is lifted. The smart hook can therefore identify an object as a concrete hopper if the object is delivered to a drop-off location at a first payload size and then removed from the drop-off location at a second, lower payload size without detecting fully unloading the object from the smart hook.

However, the smart hook can implement any other method or technique to identify and verify a type of object loaded onto the smart hook. Furthermore, upon refining an object type identification of an object carried by the smart hook, the smart hook can transmit an update of the detected object type to the remote computer system, and the remote computer system can update the manager portal to reflect this object type revision accordingly. The smart hook can also rewrite the identifier of this object type to the current lift event record.

### 7.4.1 Object Type Prediction Refinement Based on Load Status

In a similar implementation, the smart hook implements the foregoing methods and techniques to predict the type of the object loaded onto the smart hook based on an initial set of data captured by the smart hook at the beginning of the lift event and refines this prediction based on additional data captured by the smart hook as the object is fully loaded onto the smart hook, lifted by the crane, moved laterally, lowered, and unloaded from the smart hook.

In particular, the smart hook can: record its geospatial location and an initial timeseries of load data as the object is loaded onto the smart hook during a loading period; and calculate an initial prediction of the type of the object based on this pickup location and a loading profile derived from these timeseries load data. The smart hook can then: record timeseries load and motion data during a transfer period as the crane moves the smart hook and the object from the pickup location to a drop-off location; and refine the predicted type of the object based on load and motion characteristics, such as natural frequency of the object, pitching frequency and amplitude of the object, and/or “sloshing” frequency and amplitude of the object. Furthermore, the smart hook can: record its geospatial location and a final timeseries of load data as the object is unloaded onto the smart hook during an unloaded period; and further refine the predicted type of the object based on this drop-off location and an unloading profile derived from these timeseries load data.

### 7.5 Load Status

The computer system (or the smart hook) can also derive other characteristics of this lift event. In one implementation, the computer system derives a status of a load rigged on the smart hook based on: a geospatial location of the smart hook when the load is first rigged to the smart hook (i.e., a “pickup location” of the load); and material receiving, material staging, material preparation, building, and other zones defined in the site map. For example, in response to a lift event specifying a pickup location within a material loading zone defined in the site map, the computer system can automatically label this material as “inbound” to the construction site. In another example, in response to a lift event specifying a pickup location within a material staging zone defined in the site map, the computer system can automatically label this material as “install-bound” or otherwise preparing for delivery to its final location. In yet another example, in response to a lift event associated with a “concrete” material and specifying a pickup location within a concrete preparation area or a concrete truck receiving zone defined in the site map, the computer system can automatically label this material as “preparing for concrete pour” at the construction site. In another example, in response to a lift event associated with formwork and specifying a pickup location within a formwork staging zone defined in the site map, the computer system can automatically label this formwork as “install-bound”; conversely in response to a lift event associated with formwork and specifying a pickup location within or near a perimeter of the building defined in the site map, the computer system can automatically label this formwork as “stripped.”

In a similar implementation, while the smart hook carries an object, the smart hook can also identify and broadcast its status to the remote computer system for publication to the manager portal. For example, as the output of the weight sensor indicates that the load carried by the smart hook is increasing at the start of a new lift event, the smart hook can transmit a “loading” status indicator to the remote computer system. Once the output of the weight sensor indicates that the load carried by the smart hook is consistent and sufficiently intransient, and as the altimeter indicates that the altitude of the smart hook is increasing, the smart hook can: store the current payload size read by the weight sensor as a weight of the object in the current lift event record; and transmit this weight and a “loaded, lifting” status indicator to the remote computer system for publication to the manager portal. If the output of the weight sensor indicates that the load carried by the smart hook is sufficiently intransient and greater than the stored tare value and if outputs of the altimeter and geospatial position module are sufficiently intransient, the smart hook can transmit a “loaded, static” status indicator to the remote computer system for publication to the manager portal.

Furthermore, if the output of the weight sensor indicates that the load carried by the smart hook is sufficiently intransient and greater than the stored tare value, if the altimeter indicates that the altitude of the smart hook is sufficiently intransient, and if outputs of the geospatial position module are changing, the smart hook can transmit a “loaded, moving laterally” status indicator to the remote computer system for publication to the manager portal. When the output of the weight sensor indicates that the load carried by the smart hook is sufficiently intransient and greater than the stored tare value and when outputs of the altimeter indicate that the smart hook is decreasing in altitude, the smart hook can transmit a “loaded, lowering” status indicator to the remote computer system for publication to the manager portal. As the output of the weight sensor then indicates that the load carried by the smart hook is decreasing, the smart hook can transmit an “unloading” status indicator to the remote computer system. Finally, when the output of the weight sensor reaches the stored tare value, the smart hook can: close (or “end”) the new lift event record; and transmit an “unloaded” status indicator to the remote computer system for publication to the manager portal.

While the output of the weight sensor remains at approximately the stored tare value, the smart hook can return “unloaded, lifting,” “unloaded, static,” “unloaded, moving laterally,” and “unloaded, lowering” status indicators to the remote computer system for publication to the manager portal.

Furthermore, the smart hook can: record timestamps of these status changes; record concurrent geospatial locations and altitudes of the smart hook; generate timestamped, georeferenced status indicators for these status changes; and write these timestamped, georeferenced status indicators to the lift event record.

### 7.6 Lift Event Record

The smart hook can then aggregate these data—such as including object type, weight, motion, geospatial location, altitudes, and photographic images collected by the smart hook while an object is loaded on the smart hook—into a lift event record for this object.

The smart hook can additionally or alternatively derive lift event metrics from these data and write these metrics to the lift event record. For example, in addition to load type, the smart hook can: identify a staging area where the object was stored based on the geospatial location and altitude of the smart hook when the object was first loaded onto the smart hook (i.e., the pickup location) and a local copy of a site map stored on the smart hook; identify a floor or level number and a wing or region of a building where the load was delivered based on the geospatial location and altitude of the smart hook when the object was unloaded and the site map; calculate an in-air time based on a duration between initial loading and final unloading of the object; calculate a static load time based on a duration of time that the smart hook was not moving laterally or vertically between the initial loading and final unloading of the object; and/or extract peak lateral speeds, peak vertical speeds, and peak height of the smart hook between the initial loading and final unloading of the object. The smart hook can then write these metrics to the lift event record for this object (such as in addition to or in place of raw sensor data recorded during this lift event).

Alternatively, the smart hook can transmit the lift event record for this object—including raw or filtered (e.g., de-noised) sensor data—to the remote computer system upon completion of the lift event (e.g., when the output of the weight sensor returns to the stored tare value), and the remote computer system can extract the foregoing metrics from these sensor data. Yet alternatively, the smart hook can stream these sensor data to the remote computer system during the lift event, and the remote computer system can aggregate these data into a lift event record and derive the foregoing metrics and smart hook statuses from these data.

### 7.7 Remote Lift Event Identification

Alternatively the remote computer system can execute the foregoing methods and techniques to identify an object loaded onto the smart hook and to generate a lift event record based on load, geospatial location, motion, and/or camera data collected and broadcast by the smart hook during operation at the construction site. For example, the smart hook can record and transmit these data to a local wireless gateway over a local wireless network. The wireless gateway—such as located inside a cab or near a base of the crane—can then return these data to a remote computer system (e.g., a remote server) via a computer network (e.g., a computer network, a local area network). Alternatively, the smart hook can transmit these data directly to the remote computer system, such as via a cellular network. The remote computer system can then execute of the method S100 remotely to generate lift event records and to trigger alarms for the construction site.

In another example, the smart hook transmits data to a local computing device located on the construction site—such as a desktop computer, laptop computer, or mobile device—via a local wireless network; and the local computing device then executes of the method S100 locally to generate lift event records for the construction site. However, the smart hook and/or any other local or remote computer system can execute of the method S100 in (near) real-time or asynchronously to automatically generate lift event records and to issue alarms for materials and equipment moved throughout the construction site by a crane.

### 8. Construction Task Identification

Block S122 of the method S100 recites correlating the first lift event with a particular construction task defined in the construction map of the site based on the first set of load characteristics and the first geospatial location. Generally, in Block S122, the computer system can link a current lift event occurring at the smart hook to a particular construction task in the construction map based on correlations between: a material, a material weight, a pickup location, and/or a time at the start of a lift event (e.g., as or just after the material is rigged to the smart hook); characteristics of this construction task defined in the construction map; and/or previous construction tasks detected at the construction site. In particular, as the load is rigged onto the smart hook and/or as the load is first lifted at the smart hook (i.e., before the load is unloaded at its drop-off location), the computer system can associate this lift event with a particular construction task by reconciling: other construction tasks recently detected at the smart hook versus outstanding construction tasks scheduled in the construction map; a load type (and weight) detected at the smart hook versus types (and sizes) of loads specified in construction tasks in the construction map; and a current location of the smart hook (e.g., the pickup location) and scheduled pickup locations for construction tasks specified in the construction map.

In one implementation, the computer system aggregates a set of incomplete construction tasks, such as outstanding (i.e., not yet started and not yet complete) construction tasks scheduled for completion prior to the current date and scheduled for initiation on the current date. The computer system then filters this set of outstanding construction tasks for construction tasks that specify: the same or similar material as identified in the current lift event; and/or pickup locations within a threshold distance of the current location of the smart hook. Then, if a single construction task remains in this filtered set, the computer system associates the current lift event with this sole remaining construction task and then executes Block S130. Alternatively, if multiple construction tasks remain in this filtered set, the computer system can pause execution of Block S130 and instead reassess the lift event based on additional lift event data received from the smart hook data as the load is moved to and unloaded at a drop-off location.

In another implementation, the computer system calculates a confidence score that the lift event corresponds to various outstanding construction tasks. In this implementation, the computer system aggregates a set of outstanding construction tasks, such as scheduled for completion prior to and on the current date, such as described above. Then, for a first construction task in this set, the computer system calculates a confidence score that the current lift event corresponds to this first construction task: proportional to a confidence score that the load includes a material specified in the construction task; inversely proportional to a difference between a size of the load and a weight of material indicated in this construction task; proportional to a spatial proximity of the current location of the smart hook to a pickup location specified in the construction task; and/or proportional to temporal proximity of the current time to a scheduled start time of the construction task (or to a predicted start time of the construction task based on start times, completion times, and/or current statuses of preceding construction tasks). The computer system then repeats this process for each other outstanding construction task in set. Then, if a single construction task in this set is associated with a confidence score that exceeds a preset confidence threshold, the computer system associates the current lift event with this construction task and then executes Block S130 accordingly. Alternatively, if multiple construction tasks in this set are associated with confidence scores that exceed this confidence threshold or if no construction task in this set is associated with a confidence score that exceeds this confidence threshold, the computer system can delay execution of Block S130 and instead reassess the lift event based on additional lift event data received from the smart hook as the load is moved to and unloaded at a drop-off location.

### 8.1 Examples

In one example implementation, in Block S110, the computer system: accesses the building model that includes a set of discrete volumetric representations of concrete elements, structural steel elements, glazing elements, and/or ventilation elements, etc. of a building on the construction site; accesses the construction site plan that defines georeferenced locations for the building and material staging areas within the construction site; and accesses the building schedule that specifies an ordered sequence of construction tasks at the construction site (e.g., including receipt, movement, installation, and/or removal of materials and equipment throughout the construction site in the form of a calendar or Gantt chart). In Block S112, the computer system extracts the sequence of construction tasks from the building schedule. Then, for each construction task in this sequence of construction tasks, the computer system: extracts a material type from the construction task; links the construction task to a discrete volumetric representation in the building model; estimates a material quantity of the material type for the construction task based on a size of the discrete volumetric representation; estimates an unrigging geolocation of the material type for the construction task based on a position of the discrete volumetric representation in the building model, a location of the building in the construction site plan, and/or material staging areas defined in the construction site plan; and then stores the material type, the material quantity, and the unrigging location in a construction task object for the construction task.

For example, the computer system can link the construction task to a discrete volumetric representation in the building model based on: the material type and a material code of the volumetric representation in the building model; an order of the construction task in the sequence of construction tasks and a position of the volumetric representation in the building model (e.g., by pairing earlier construction tasks with volumetric representations at lower altitudes within the building model); and/or similarities between keywords or descriptive content in the construction task and the discrete volumetric representation in the building model.

Then, in this example implementation, the computer system can access an object type and an object weight detected by the smart hook during a lift event in Block S120 and correlate this lift event with a particular construction task based on: alignment between the object type and a particular material type specified in a particular construction task object for the particular construction task; alignment between the first object weight and a particular material quantity specified in the particular construction task object; and alignment between the drop-off location and a particular unrigging geolocation specified in the particular construction task object.

Furthermore, in this example implementation, for a first construction task in the sequence of construction tasks, the computer system can derive a link to one or a group of preceding construction tasks requiring completion prior to the first construction task, such as based on preset construction task order rules (e.g., concrete pour preceded by formwork side-B installation, preceded by rebar installation, preceded by formwork side-A installation; material installation preceded by material storage in a holding zone on the construction site preceded by material receipt at a receiving zone on the construction site). The computer system can repeat this process for other construction tasks in the sequence. Later, the computer system can correlate a lift event with a particular construction task further based on completion of a second construction task prior to the lift event if the particular construction task includes a link requiring completion of the second construction task prior to the particular construction task.

Additionally or alternatively, in this example implementation, the computer system can access a set of confidence scores for types of an object carried by the smart hook during a lift event, a weight of the object, and a time of the lift event—such as derived locally by the smart hook—in Block S120. The computer system can then correlate this lift event with a particular construction task in Block S130 by identifying a subset of incomplete construction tasks in the sequence of construction tasks for the construction site. For each construction task in the subset of incomplete construction tasks, the computer system can calculate a similarity score between the lift event and the first construction task: proportional to a confidence score—in the set of confidence scores for types of the object carried by the smart hook during a lift event—for an object type specified in the construction task; inversely proportional to a difference between the weight of the object and a material weight specified in the construction task; proportional to a spatial proximity of the drop-off location to a material staging location specified in the construction task; and/or proportional to a temporal proximity of the time of the lift event to a scheduled start time of the construction task. The computer system can then correlate the lift event with a particular construction task—in the subset of incomplete construction tasks—if a similarity score of the particular construction task exceeds a threshold similarity score and similar scores for all other construction tasks in the subset of incomplete construction tasks.

### 9. Smart Hook Unloading

In one variation, the computer system derives additional characteristics of this lift event based on data received from the smart hook as the load is moved to and unloaded at a drop-off location.

In one example, the computer system derives: a georeferenced 3D path from the pickup location to the drop-off location; an altitude and a geospatial location of the drop-off location; a floor of a building to which the load is delivered (e.g., based on the altitude of the drop-off location); a region or wing of a building to which the load is delivered (e.g., based on the geospatial location of the drop-off location); and/or an unload time from the smart hook from additional data received from the smart hook during this lift event. In another example, the computer system derives or confirms a status of the load based on the drop-off location of the load, such as by confirming an “inbound” status of a load rigged to the smart hook at a specified material receiving location and unloading at a material staging location on the construction site.

### 10. Construction Task Confirmation

In one variation, the computer system predicts or confirms an association between the current lift event and a particular construction task further based on the foregoing additional lift event characteristics.

In one example in which multiple construction tasks remain in a set of construction tasks filtered according to lift event characteristics derived from data collected at and around the pickup location, the computer system further filters this set of construction tasks based on proximity of drop-off location specified in the construction tasks and the actual drop-off location of the current lift event.

In another example, the computer system further refines a confidence score for association between a construction task and the current lift event proportional to proximity of the drop-off location specified in this construction task to the actual drop-off location of the current lift event. The computer system can then confirm an association between this lift event and a particular construction task for which the computer system has calculated a highest confidence score.

However, the computer system can implement any other method or technique to derive an association (or correlation) between the current lift event and a particular construction task in the construction map.

### 11. Construction Task Status

In one variation, after associating the lift event with a particular construction task, the computer system can interpret a new status of the particular construction task and update a construction record for the construction site accordingly.

In one implementation, the computer system interprets a first lift event in which a particular material is first unloaded within a perimeter of the building—following lift events specifying other materials and corresponding to other construction tasks—as the start of a next construction task specifying this material. The computer system then updates the status of this next construction task to “active” and stores a time of the lift event as a start time of this construction task. In this implementation, the computer system can also indicate that a second “active” construction task gating the newly-active construction task is now “complete” (or nearing completion) and store the time of the current lift event as an end time of this second construction task.

Later, in response to detecting a second (or third, fourth, etc.) lift event in which this same material is delivered at or near the same pickup location, the computer system can associate this second lift event with the same construction task and fuse quantities of the material delivered to the building across these lift events to estimate a degree of completion of this construction task. For example, the computer system can: estimate or extract a total weight of a material for this construction task from the construction map (e.g., five tons of formwork; 100 tons of concrete, 3000 pounds of drywall); track the weight of this material delivered to a particular floor or wing of the building across multiple lift events while the construction task specifying this material is active; estimate a proportion of the weight of this material delivered to the total weight of this material allocated to this construction task; and estimate the progress through this construction task (e.g., a proportion of the construction task completed) based on this proportion. The computer system can then update the status of this construction task according to the estimated proportion of the construction task completed and/or derive a progress rate of this construction task based on times of these lift events within this construction task.

However, the computer system can derive the status of this construction task in any other way. The computer system can then store the status of the computer system and a time of this status in the construction record for the construction site.

In one variation, the computer system derives additional metrics from data collected during this lift event and stores these data with an identifier of the construction task. For examples, the computer system can: aggregate a list of tools and equipment detected near the drop-off location; calculate net and gross durations of this lift event and other like lift events in this construction task; calculate a quantity of humans detected near the pickup and/or drop-off locations; calculate an in-air or motionless time of the load during the lift event; and/or calculate a difference between a quantity of a material delivered to a drop-off location and a quantity of the material planned for this region of the construction site. The computer system can then store these data with the construction task and serve these data to the user, such as when the user selects a notification related to this construction task, as described below.

### 12. Notification Triggers

Block S130 of the method S100 recites querying a set of notification triggers, linked to construction tasks defined in the construction map, for a notification trigger specifying characteristics of the lift event and the particular construction task. Generally, in Block S130, the computer system can identify a notification trigger—associated with the user's profile—that specifies construction task features matched to the features of a construction task with a recent status change and generates a notification for the user accordingly.

In one example, if the user's profile contains a notification trigger that identifies this construction task specifically (e.g., installation of perimeter scaffolding), the computer system can populate a new notification with: a description or identifier of the construction task; a start time of the construction task (or a pickup time of the lift event associated with the construction task); and an image of the load captured by the smart hook when the material was rigged onto the smart hook or unloaded at the drop-off location.

In another example in which the user profile includes a notification trigger specifying any instance of a particular construction task (e.g., installation of overhead formwork scaffolding for a cast-in-place concrete floor), the computer system can implement methods and techniques described above to match the current construction task to this notification trigger. The computer system can then populate a notification with: a description or identifier of this construction task; a numerical value representing the instance of this construction task; a start time of this instance of the construction task; and a drop-off location of the corresponding lift event, which indicates a primary location of this instance of the construction task at the construction site.

In another example in which the user profile includes a notification trigger specifying a particular material rigged at a particular location, the computer system can match the current construction task to this notification trigger based on the material detected at the smart hook during the current lift event and a location of the smart hook when this material is rigged onto the smart hook. Accordingly, the computer system can populate a notification with: a description or identifier of this construction task; a description or identifier of this material; a weight of this material rigged to the smart hook; the pickup location of the material; and a start time of this lift event.

In a similar example in which the user profile includes a notification trigger specifying a particular material delivered to a particular location, the computer system can match the current construction task to this notification trigger based on the material detected at the smart hook during the current lift event and a location of the smart hook when this material is unloaded from the smart hook. Accordingly, the computer system can populate a notification with: a description or identifier of this construction task; a description or identifier of this material; a weight of this material rigged to the smart hook; the drop-off location of the material; and an end time of this lift event.

In yet another example in which the user's profile includes a notification trigger that specifies a deviation from a particular order of a set of construction tasks, the computer system can: implement the foregoing methods and techniques to match a series of preceding lift events to a first subset of construction tasks in this set; link the current lift event to a second construction task in this set; and then generate a notification if this notification trigger specifies a third construction task between the first subset of construction tasks and the second construction task. Accordingly, the computer system can populate the notification with: identifiers of these completed and in-process construction tasks; an identifier of the third construction task thus occurring out of order; and a location or region on the construction site in which the construction tasks have occurred (e.g., a boundary containing drop-off locations of each lift event linked to these construction tasks).

However, the computer system can match features and characteristics of the current construction task and/or lift event to a notification trigger in any other way in Block S130.

### 13. Notification Delivery

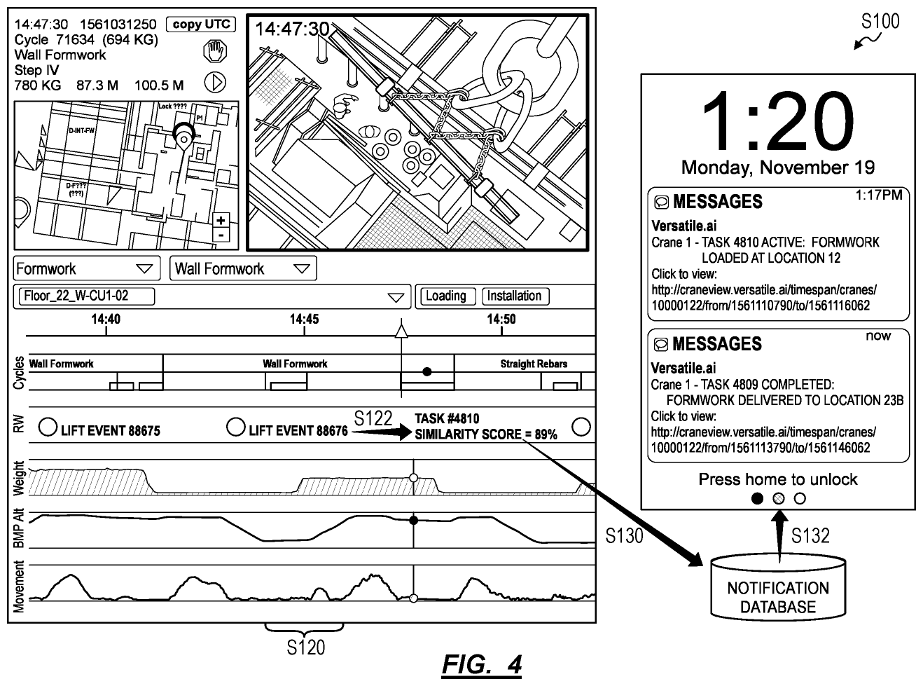

Block S132 of the method S100 recites, in response to identifying the notification trigger, transmitting a notification to a user portal associated with an author of the notification trigger. Generally, in Block S132, the computer system can serve a notification—based on a notification trigger and features of a current construction task or lift event—to the user in (near) real-time, as shown in FIG. 4.

For example, the computer system transmits the notification to the user—within seconds or minutes of identifying the current construction task—in the form of: a SMS or MMS message; an in-application notification; and/or an alert within an alert feed (or construction task feed) rendered within the user portal, such as viewed within a native application or web browser executing on the user's computing device. Alternatively, if the computer system matches the current construction task to a particular notification trigger that specifies a notification delay, the computer system can: implement methods and techniques described above to generate a notification responsive to this notification trigger; initiate a timer for the delay duration defined in the notification trigger; and then transmit the notification to the user in response to expiration of this timer.

In one example, upon receipt of this notification, the user's computing device can render the notification for the user. When the user selects the notification, a native application (or web browser) executing on the user's computing device can: open the user portal; render a graphical user interface within the user portal; and populate the graphical user interface with additional media. For example, the native application can populate the graphical user interface with: an image of the material when loaded on the smart hook; a video feed captured by the smart hook over the duration of the lift event or construction task; a map of the construction site annotated with the pickup location and/or the drop-off location of the corresponding lift event; and/or lift event details, such as material type, material weight, pickup time, drop-off time, rigging and unrigging durations, and/or in-air duration.

Thus, the computer system can identify the start of a construction task in-process at the site in Block S122 based on: a material identified from data collected by the smart hook during a lift event; the location of the smart hook when the material is loaded onto the smart hook during a lift event; and/or the location of the smart hook when the material is unloaded from the smart hook. Furthermore, the computer system can thus identify a notification trigger—assigned to a particular user—that specifies characteristics of this construction task and transmit a notification for this construction task to this user's computing device in (near) real-time, such as within seconds or minutes of the start or end of the corresponding lift event. The computer system can implement similar methods and techniques to transmit a notification—in (near) real-time—to the user according to a notification trigger outlined in the user's profile when the computer system detects: the end of a construction task; an intra-task event or milestone (e.g., 50% of formwork unloaded at the building); and/or a particular lift event characteristic based on data received from the smart hook during this construction task.

Therefore, by selectively returning notifications to the user according to the notification parameters outlined in the user's profile, the computer system can enable the user to monitor specific processes of interest occurring on the construction site and to initiate preemptive actions to maintain a construction schedule without relying on other workers onsite to communicate construction task statuses back to the user. For example, the computer system can generate a notification—according to a notification trigger defined by the user—when a last batch of formwork is delivered to a first side of a rebar structure on the site; and then transmit this notification to the user in (near) real-time. Accordingly, the user may schedule an inspector to inspect the rebar structure and the first side of the formwork around this rebar structure before the second side of the rebar structure is enclosed by formwork.

### 14. Example: Material Quantity Delivered

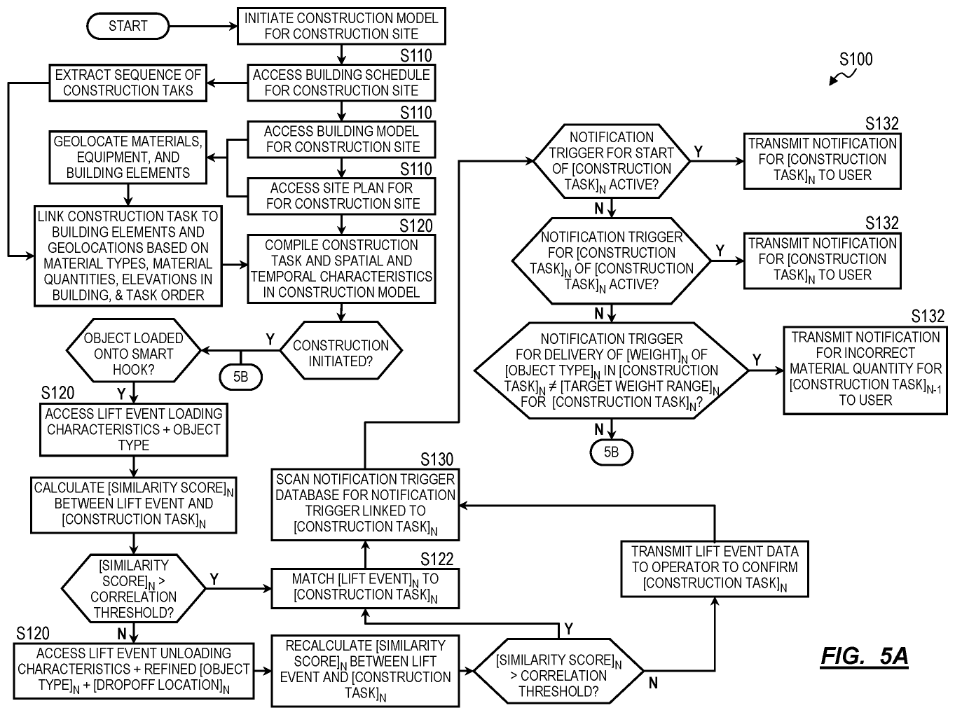

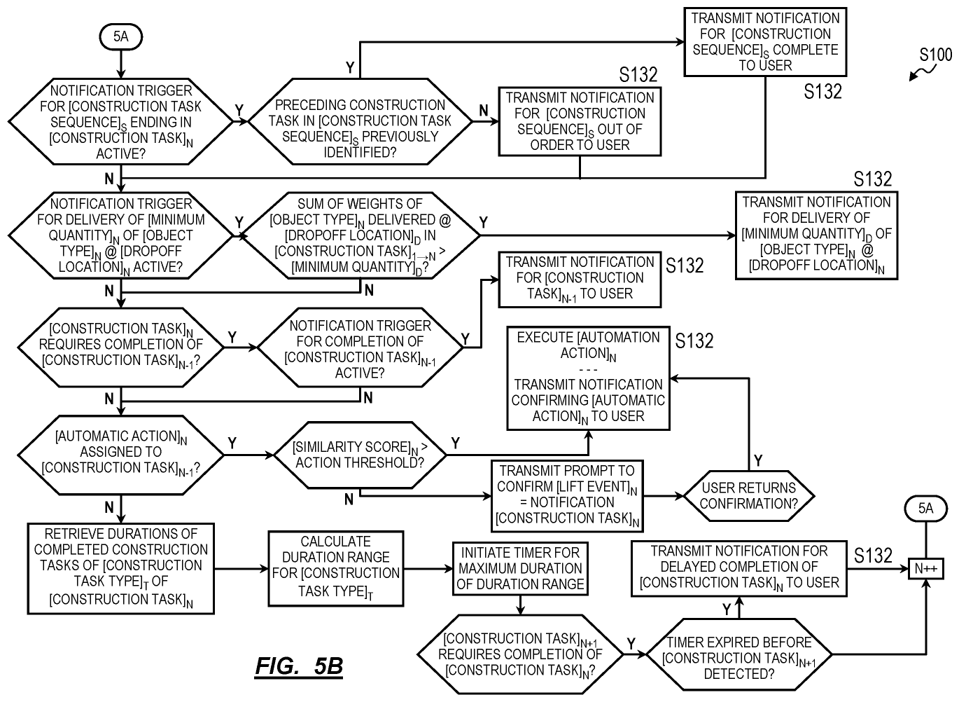

In one example implementation shown in FIG. 5B, the computer system generates a notification trigger for delivery of a minimum quantity of a target material type to a target location at the construction site during a setup period. For example, the computer system can interface with the user via the user portal to: select a material type from a list of construction materials extracted from the building map; select a target location or define a geofenced area within the map of the construction site; record a minimum quantity of the selected material type delivered within the geofenced area; and assemble these inputs into a notification trigger with material type, delivery location, and weight specifications. The computer system can then sum weights of objects of this material type delivered to the target location over time—detected based on data collected by the smart hook—and serve a notification to the user when this weight sum exceeds the minimum quantity specified in the notification trigger.

For example, during operation, the computer system can: access a first type of a first object—carried by the smart hook during a first lift event—derived from data captured by the smart hook during the first lift event; access a first weight of the first object similarly derived from data captured by the smart hook during the first lift event; access a first drop-off location of the first object during the first lift event; correlate the first lift event with the notification trigger according to alignment between the first object type, the first drop-off location, and the material and target location specified in the notification trigger. The computer system can also withhold a notification for the first lift event if the first weight of the first object is less than the minimum quantity of the material specified in the notification trigger.

Later, the computer system can: access a second type of a second object—carried by the smart hook during a second lift event succeeding the first lift event—derived from data captured by the smart hook during the second lift event; access a second weight of the second object similarly derived from data captured by the smart hook during the second lift event; and access a second drop-off location of the second object during the second lift event. The computer system can then link the first and second lift events given alignment between (e.g., similarity of, proximity of): the first object type and the second object type; and the drop-off location and the second drop-off location. Accordingly, the computer system can: compile the first and second lift events into one construction task; and calculate a sum of the first and second weights of the first and second objects from the first and second lift events.

Finally, the computer system can generate and serve a notification for delivery of the material type to the target location on the construction site to the user if the sum of these weights exceeds the minimum quantity of the target material type specified in the notification trigger.

Furthermore, in this example, when the first lift event is completed and prior to the second lift event, the computer system can also: estimate a completion ratio of the construction task at a time of the first lift event based on a ratio of the first weight of the first object to the quantity of the material type specified in the construction task; and publish this completion ratio of the construction task to a construction task feed—such as rendered on a public display within a managerial office at the construction site or within a public construction site portal—at the time of the first lift event. The computer system can then recalculate this completion ratio and update the construction task feed accordingly upon completion of the second lift event.

### 15. Example: Incorrect Material Quantity

In a similar example implementation shown in FIG. 5A, the computer system generates a notification trigger for delivery of an incorrect amount of a material to a particular location within the jobsite (e.g., to a building area, to a receiving zone). More specifically, the computer system can interface with the user during a setup period to generate a notification trigger for deviation from a target quantity range for a target material type delivered to a target location at the construction site. Later, the computer system can: match this notification trigger to a lift event based on: alignment between the target material specified in the notification trigger and a type of object detected during the lift event; alignment between the target location specified in the notification trigger and a drop-off location recorded during the lift event; and deviation of the weight of the object detected during the lift event from the target quantity range specified in the notification trigger. The computer system can then transmit a notification to the user's computing device accordingly.

In this example, the computer system can also link a target quantity range for a notification trigger to a weight of another object detected during an earlier lift event.

Thus, in this example implementation, the computer system can notify the user: when an insufficient amount of a material is received at the construction site; when too much material is unloaded at a particular building location; or when the ratio of two materials unloaded at a particular building location deviates from a target ratio range (e.g., concrete to rebar weight of ratio 20:1 to 22:1).

### 16. Example: Completed Construction Task

In another example implementation shown in FIG. 5B, the computer system generates a notification trigger for completion of a particular construction task. For example, the computer system can interpret—from the sequence of construction tasks or the building schedule more generally—a construction task sequence limitation for completing the particular construction task (e.g., installing formwork at a particular location) prior to start of a second construction task (e.g., pouring concrete at the particular location). More specifically, the computer system can determine that the particular construction task must be completed prior to start of a second construction task based on the sequence of construction tasks or the building schedule more generally. The computer system can also: interface with the user via the user portal to create a notification trigger for completion of the particular construction task; and write detection of the second construction task (e.g., delivery of a concrete hopper to the particular location, thus indicating a start of the second construction task) to this notification trigger according to the construction task sequence limitation. Later, upon correlating a lift event with the second construction task and thus detecting the second construction task, the computer system can transmit a notification specifying completion of the particular construction task to the user's computing device according to this notification trigger.

### 17. Example: Delayed Construction Task

In a similar example implementation shown in FIG. 5B, the computer system generates a notification trigger for delayed completion of a particular construction task.

For example, the computer system can interpret a construction task sequence limitation for completing the particular construction task (e.g., installing formwork at a particular location) prior to start of a second construction task (e.g., pouring concrete at the particular location) as described above. The computer system can also: interface with the user via the user portal to create a notification trigger for delayed completion of the particular construction task; extract a target completion time and/or completion date from the building schedule; and write detection of the second construction task (e.g., delivery of a concrete hopper to the particular location, thus indicating a start of the second construction task) by the target completion time and/or completion date to this notification trigger according to the construction task sequence limitation. Later, upon failure to correlate a lift event with the second construction task by the target completion time and/or completion date of the particular construction task, the computer system can transmit a notification—specifying failure to complete the particular construction task on time—to the user's computing device according to this notification trigger.

Similarly, the computer system can extract a target duration to complete a particular construction task from the building schedule or prompt the user to enter a time limit for completion of this particular construction task; and write this duration or time limit for the particular construction task to the notification trigger. Later, upon correlating a lift event with this particular construction task, the computer system can initiate a timer for this duration for the time limit. If the computer system fails to correlate a second lift event with the second construction task that indicates completion of the particular construction task prior to expiration of the timer, the computer system can transmit a notification—specifying a duration anomaly for the first construction task—to the user's computing device according to the notification trigger.

In another example, the computer system can: interface with the user to generate a notification trigger specifying anomalous task duration of construction task type (e.g., installing formwork); identify a set of construction tasks of this construction task type (i.e., a set of “analogous” construction tasks); and link these construction tasks to the notification trigger. During operation at the construction site, the computer system can implement methods and techniques described above: to identify a start of a construction task in this set based on a lift event associated with this construction task (e.g., delivery of formwork to a building area within the construction site); and to identify completion of the construction task based on a later lift event associated with a second construction task requiring completion of the prior construction task (e.g., delivery of a concrete hopper to the building area after formwork is installed). The computer system can then: calculate a duration of the construction task based on a difference between the start and completion times; repeat this process for other construction tasks of this construction task type completed at the construction site; and calculate a combination of the durations of construction tasks of this construction task type, such as an average of these durations or a weighted average of these durations with greater weights applied to more recent instances of the construction task, as shown in FIG. 5B.

Later, upon correlating a lift event with a construction task of this construction task type, the computer system can initiate a timer for the current average duration for this construction task type, such as with a variance buffer (e.g., no % of the current average duration of the construction task type; or one standard deviation). If the computer system fails to correlate a second lift event with the second construction task that indicates completion of this construction task prior to expiration of the timer, the computer system can transmit a notification—specifying a duration anomaly for the first construction task—to the user's computing device according to the notification trigger.

Therefore, in this variation, the computer system can estimate the duration of construction tasks of a particular construction task type (e.g., based on types of other linked construction tasks detected at the construction site) and automatically notify the user in response to the duration of a current instance of this construction task type deviating from past instances of this construction task type.

### 18. Example: Disordered Construction Task

In another example implementation shown in FIG. 5B, the computer system generates a notification trigger for a sequence of construction tasks occurring out of order. For example, the computer system can: receive, from the user via the user portal, a selection of an ordered subset of construction tasks, such as including a first construction task (e.g., delivery of formwork to a building location) followed by a second construction task (e.g., delivery of a concrete hopper to the building location); and then define a notification trigger for deviation from the ordered subset of construction tasks based on this selection. Later, if the computer system correlates a lift event with the second construction task prior to correlating another lift event with the first construction task, the computer system can: identify an out-of-order event at the construction site; and transmit a notification to the user's computing device for this out-of-order event accordingly.

### 19. Example: Analogous Construction Task

In yet another example implementation shown in FIG. 5A, the computer system: publishes detected construction tasks occurring at the construction site to a construction task feed; interfaces with the user via the user portal to set a notification trigger for future construction tasks analogous to (e.g., of the same construction task type as) a particular construction task selected from the construction task feed by the user; and later notifies the user when the computer system identifies these analogous construction tasks.

For example, the computer system can: detect a first sequence of lift events occurring at the construction site based on data captured by the smart hook during a first construction period; correlate this first sequence of lift events with a first subset of construction tasks in a sequence of construction tasks scheduled at the construction site; update current statuses of the first subset of construction tasks based on the first sequence of lift events; and indicate the current statuses of this first subset of construction tasks in a construction task feed rendered on the user's computing device. When viewing this construction task feed, such as within the user portal, the user may identify a particular construction task of a particular construction task type that she desires to be notified of in real-time. The computer system can thus: record selection of this particular construction task from the construction task feed; identify a second subset of incomplete construction tasks—in the sequence of construction tasks—that are analogous to (e.g., of the same construction task type as) the particular construction task; and then assign a notification trigger to each construction task in this second subset of incomplete construction tasks. Later, the computer system can serve notifications to the user in response to correlating lift events with these construction tasks.

### 20. Automated Action

In one variation shown in FIG. 5B, the computer system interfaces with the user via the user portal to link a notification trigger to an automated action. Then, when the computer system detects a construction task or lift event that matches this notification trigger in Block S130, the computer system can automatically execute this action.

For example, the computer system can interface with the user to populate a notification trigger with a command to automatically: transmit an inquiry to an inspector (e.g., via email, calendar invite, or text message) to inspect a particular structure (e.g., installed rebar) on the construction site; submit an electronic work order for delivery of a particular material from an offsite storage location; transmit an electronic notification to workers to begin staging a particular material (e.g., sorting pre-formed rebar sections); or transmit an electronic notification to workers to begin preparing a particular material on the construction site (e.g., mixing concrete; insert a new lift event into a crane operator schedule). Thus, when the computer system links a current construction task to a notification trigger specifying an automated action, the computer system can automatically execute this action on behalf of the user.

More specifically, in this variation, the computer system can: interface with the user via the user portal to configure an automatic action; and then link this automatic action to a particular construction task (or to construction tasks of a particular construction task type). Later, the computer system can: calculate a similarity score representing similarity (or “alignment,” confidence in correspondence) between a lift event and the particular construction task based on a set of load characteristics and a drop-off location captured during the lift event in Block S122; correlate this lift event with the particular construction task if this similarity score exceeds a correlation threshold; and then execute the automatic action linked to the particular construction task in response to correlating the lift event with the particular construction task.

For example, the computer system can interface with the user to configure an automatic action to schedule a building inspection (e.g., by sending a email, text message, or voicemail preconfigured by the user to a stored building inspector address): in response to delivery of a threshold quantity of rebar to a building location (e.g., over multiple lift events), which indicates that workers are preparing to install a final section of rebar in this building location; or in response to delivery of a particular steel girder to a particular building location. In another example, the computer system interfaces with the user to configure an automatic action: to place a material order for concrete (e.g., by sending a email, text message, or voicemail preconfigured by the user to a stored concrete supplier address) in response to delivery of a threshold quantity of formwork to a building location (e.g., over multiple lift events), which indicates that workers are preparing to enclose a final section of rebar in this building location; or to place a material order for steel girders in response to initial transfer of formwork from the building location to a staging area, which indicates that workers are stripping cast-in-place concrete structures and are preparing to install steel sections. In a similar example, the computer system interfaces with the user to configure an automatic action to place an equipment order for formwork (e.g., by sending a email, text message, or voicemail preconfigured by the user to a stored formwork supplier address) in response to initial transfer of pier drilling equipment from the building foundation location to a staging area, which indicates that workers have complete pier construction and are preparing to form a concrete structure. In another example, the computer system interfaces with the user to configure an automatic action to schedule a subcontractor action, such as glazing installation in response to delivery of a threshold quantity of precast concrete structures along a perimeter of the building over multiple lift events. In these examples, the computer system can implement methods and techniques described above to detect one or a sequence of lift events and/or construction tasks that fulfill triggers linked to these automatic actions and then autonomously execute these automatic actions accordingly.

Furthermore, in this variation, the computer system can autonomously execute an automatic action in response to identifying a construction task—linked to this automatic action—with a high confidence. However, if the computer system identifies a lift event as a construction task—linked to an automatic action—with a low(er) confidence, the computer system can prompt the user to confirm the construction task before executing the automatic action. For example, the computer system can implement methods and techniques described above to calculate a similar score between a lift event and a construction task based on an object type, an object weight, a pickup location, a drop-off location, a scheduled construction task order, lift event duration, a trajectory of the smart hook during the lift event, etc. Then, if this similarity score is high (e.g., greater than an action threshold of 90%) and this construction task is linked to an automatic action, the computer system can: autonomously execute the automatic action; and transmit a notification indicating completion of the first construction task and completion of the automatic action to the user's computing device. However, if this similarity score is sufficient to identify the lift event as the construction task but not sufficient to execute the automatic action autonomously (e.g., the similarity score exceeds a correlation threshold of 80% but is less than the action threshold of 90%), the computer system can: transmit—to the user's computing device—a notification: indicating detection of the construction task; depicting various data collected during the lift event (e.g., load characteristics and/or an image of the object captured by the smart hook during the lift event); and containing a prompt to confirm identification of the construction task and/or execution of the automatic action. Then, if the user confirms identification of the construction task and/or execution of the automatic action, the computer system can automatically execute the automatic action.

### 21. Process and Progress Visualization

In one variation, the computer system can transform construction tasks thus detected at the construction site into a visualization of past and current processes and progress at the construction site.

In one implementation, the computer system initializes a 3D virtual environment representing the construction site—such as including virtual representations of the crane, material receiving zones, material staging zones, etc.—based on the site plan described above. The computer system then: links a first construction task detected at the construction site to a first discrete volumetric representation of a first building element (e.g., rebar, a cast concrete element, a steel girder) defined in the building model described above; retrieves a virtual 3D model of a raw material for this first building element; and scales this virtual 3D model of the raw material according to a weight or size of the load detected at the smart hook during the corresponding lift event. The computer system further generates a set of 3D animations for this first construction task into the 3D virtual environment, including: a first animation depicting the scaled virtual 3D model of the raw material moving from the pickup location at the start time of the lift event to the drop-off location at the end of this lift event; and a second animation depicting the scaled virtual 3D model of the raw material transitioning into the first discrete volumetric representation of the first building element over a period of time from the end of this lift event to the end of this construction task. The computer system then populates the 3D virtual environment of the construction site with: the scaled virtual 3D model of the raw material at the pickup location; a transition to the first animation at the start time of the lift event; then a transition to the second animation at the end time of the lift event; and finally the first discrete volumetric representation of the first building element at the building location.

In the foregoing implementation, the computer system can repeat this process to insert static objects and timed animations representing completed and in-process construction tasks related to installation of building elements at the construction site. The computer system can implement similar methods and techniques to insert static objects and timed animations representing completed and in-process construction tasks related to receiving, preparation, and movement of raw material and tools throughout the construction site.

The computer system can then compile these objects and timed animations in the 3D virtual environment into a 4D visualization depicting movements of virtual representation of raw materials and tools spatially and temporally synchronized to real past and current construction tasks occurring at the construction site.

The computer system can then serve this 4D visualization to the user's computing device, which can render this 4D visualization for the user and thus enable the user to rapidly visualize construction tasks and material movement history at the construction site. For example, the native application or web browser executing on the user's computing device can: prompt the user to select a start time for the 4D visualization; prompt the user to set a viewing perspective for the 4D visualization (e.g., a plan, elevation, or isometric view and a zoom magnitude); prompt the user to select a playback speed (e.g., 100,000×, 1,000,000×); and then replay the 4D visualization according to these parameters (e.g., 100 days of construction replayed in 87 seconds at 1,000,000× playback speed).

### 22. Other Sensors

In one variation, the computer system can implement similar methods and techniques to identify construction tasks occurring on the construction site based on data received from other sensors installed or deployed throughout the construction site, such as: locations of workers received from geospatial location transmitters worn by these workers; locations of tools received from geospatial location transmitters installed on these tools; locations of materials received from geospatial location transmitters installed on these materials; cameras and motion sensors received from cameras and other sensors installed inside of a building; etc. The computer system can then implement methods and techniques similar to those described above to selectively generate notifications according to notification triggers specifying features of these construction tasks, such as: when a minimum quantity of workers aggregate in a particular location at the construction site; when a particular worker enters a particular location; or when a particular tool is installed or arrives in a particular location at the construction site.

### 23. Other Actions

In one variation, the computer system and/or the smart hook can implement similar methods and techniques to: detect materials on the ground and/or on the building—and not connected to the smart hook—in images (or a video feed) captured by the smart hook while moving throughout the construction site; and then selectively transmit notifications to the user based on responsive to detecting presence or changes in materials, material quantities, and/or material locations over time and parameters specified in notification triggers stored in the user's profile. The computer system can implement similar methods and techniques to serve notifications to the user based on materials detected in images (or a video feed) captured by other cameras deployed on the construction site, such as a fixed camera arranged inside of the building.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for monitoring processes and progress at a construction site comprising:
accessing a building model and a site plan for the construction site;
compiling the building model and the construction site plan for the construction site into spatial and temporal representations of a sequence of construction tasks planned on the construction site;
accessing a first set of load characteristics derived from data captured by a smart hook, arranged on a crane operated at the construction site, and a drop-off location of the smart hook during a first lift event at the crane;
correlating the first lift event with a first construction task, in the sequence of construction tasks, based on the first set of load characteristics and the drop-off location;
querying a set of notification triggers, affiliated with a user and linked to the sequence of construction tasks, for a first notification trigger specifying characteristics of the first construction task; and
in response to identifying the first notification trigger, transmitting a first notification to a computing device, associated with the user, according to the first notification trigger.

2. The method of claim 1:
further comprising, during a setup period preceding the first lift event:
configuring an automatic action according to an input from the user at the computing device; and
linking the automatic action to the first construction task;
wherein correlating the first lift event with the first construction task comprises:
calculating a similarity score between the first lift event and the first construction task based on the first set of load characteristics and the drop-off location; and
correlating the first lift event with the first construction task in response to the similarity score exceeding a correlation threshold; and
further comprising executing the automatic action in response to correlating the first lift event with the first construction task.

3. The method of claim 2:
wherein transmitting the first notification to the computing device comprises:
in response to the similarity score exceeding an action threshold, transmitting, to the computing device, the first notification indicating completion of the first construction task and completion of the automatic action; and
in response to the similarity score exceeding the correlation threshold and falling below the action threshold, transmitting, to the computing device, the first notification:
indicating detection of the first construction task;
depicting the first set of load characteristics; and
comprising a prompt to confirm the automatic action; and
further comprising, in response to receipt of confirmation of the automatic action from the computing device, executing the automatic action.

4. The method of claim 2, wherein configuring the automatic action comprises configuring the automatic action selected from the set of automatic actions comprising scheduling a building inspection, placing a material order, placing an equipment order, and scheduling a subcontractor action.

5. The method of claim 1:
further comprising, during a setup period preceding the first lift event:
receiving, from the user via the computing device, a selection of an ordered subset of construction tasks comprising the first construction task following a second construction task in the sequence of construction tasks; and
based on the selection, defining the first notification trigger for deviation from the ordered subset of construction tasks; and
wherein transmitting the first notification to the computing device comprises transmitting the first notification to the computing device in response to correlating the first lift event with the first construction task prior to detecting a second lift event correlated with the second construction task.

6. The method of claim 1:
further comprising, during a setup period preceding the first lift event, generating the first notification trigger for deviation from a target quantity range for a target material type delivered to a target location at the construction site;
wherein accessing the first set of load characteristics comprises:
accessing a type of an object carried by the smart hook during the first lift event, the type of the object derived from data captured by the smart hook during the first lift event; and
accessing a weight of the object, the weight of the object derived from data captured by the smart hook during the first lift event; and
wherein querying the set of notification triggers for the first notification trigger specifying characteristics of the first construction task comprises matching the first notification trigger to the first construction task based on:
alignment between the target material and the type of the object;
alignment between the target location and the drop-off location; and
deviation of the weight of the object from the target quantity range.

7. The method of claim 1:
further comprising:
during a setup period preceding the first lift event, generating the first notification trigger for delivery of a minimum quantity of a target material type to a target location at the construction site;
accessing a second type of a second object carried by the smart hook during a second lift event preceding the first lift event, the second type of the second object derived from data captured by the smart hook during the second lift event;
accessing a second weight of the second object, the second weight of the second object derived from data captured by the smart hook during the second lift event; and
accessing a second drop-off location of the second object during the second lift event;
wherein accessing the first set of load characteristics comprises:
accessing a first type of a first object carried by the smart hook during the first lift event, the first type of the object derived from data captured by the smart hook during the first lift event;
accessing a first weight of the first object, the first weight of the object derived from data captured by the smart hook during the first lift event;
wherein correlating the first lift event with the first construction task comprises correlating the first lift event and the second lift event with the first construction task in response to alignment between:
the first object type and the second object type; and
the drop-off location and the second drop-off location; and
wherein querying the set of notification triggers for the first notification trigger specifying characteristics of the first construction task comprises matching the first notification trigger to the first construction task based on:
alignment between the target material and the type of the object;
alignment between the target location, the first drop-off location, and the second drop-off location; and
a sum of the first weight and the second weight exceeding the minimum quantity of the target material type.

8. The method of claim 7, further comprising:
prior to the first lift event, correlating the second lift event with the first construction task based on the second object type and the second drop-off location;
estimating a completion ratio of the first construction task at a time of the second lift event based on a ratio of the second weight of the second object to a target quantity of the target material type specified in the first construction task; and
publishing the completion ratio of the first construction task to a construction task feed at approximately the time of the second lift event.

9. The method of claim 1:
further comprising, during a setup period preceding the first lift event:
generating the first notification trigger for completion of a second construction task;
interpreting a construction task sequence limitation for completing the second construction task prior to start of the first construction task from the sequence of construction tasks; and
based on the construction task sequence limitation, writing detection of the first construction task to the first notification trigger; and
wherein transmitting the first notification to the computing device comprises transmitting the first notification specifying completion of the second construction task to the computing device according to the first notification trigger in response to correlating the first lift event with the first construction task.

10. The method of claim 1:
further comprising:
during a setup period preceding the first lift event:
generating the first notification trigger for delayed completion of the first construction task;
interpreting a construction task sequence limitation for completing the first construction task prior to start of a second construction task from the sequence of construction tasks; and
writing the construction task sequence limitation to the first notification trigger;
further comprising:
retrieving a duration limit of the first construction task; and
initiating a timer for the duration limit in response to correlating the first lift event with the first construction task; and
wherein transmitting the first notification to the computing device comprises, based on the construction task sequence limitation, transmitting the first notification to the computing device in response to expiration of the timer prior to correlation of a second lift event at the smart hook with the second construction task, the first notification specifying a duration anomaly for the first construction task.

11. The method of claim 10, wherein retrieving the duration limit of the first construction task comprises:
identifying a subset of construction tasks, in the sequence of construction tasks, analogous to the first construction task and completed at the construction site prior to the first lift event;
retrieving a set of durations of the subset of construction tasks; and
calculating the duration limit for the first construction task based on a combination of the set of durations.

12. The method of claim 1:
further comprising:
detecting a first sequence of lift events occurring at the construction site based on data captured by the smart hook during a first construction period;
correlating the first sequence of lift events with a first subset of construction tasks in the sequence of construction tasks;
updating current statuses of the first subset of construction tasks based on the first sequence of lift events;
indicating current statuses of the first subset of construction tasks in a construction task feed rendered on the computing device;
receiving, from the user, a selection of a particular construction task from the construction task feed;
in response to receiving the selection:
identifying a second subset of incomplete construction tasks, in the sequence of construction tasks, analogous to the particular construction task; and
assigning the first notification trigger to the second subset of incomplete construction tasks; and
wherein correlating the first lift event with the first construction task comprises correlating the first lift event with the first construction task, in the second subset of incomplete construction tasks, based on the first set of load characteristics and the drop-off location.

13. The method of claim 1:
wherein accessing the first set of load characteristics comprises:
accessing a first timeseries of load values output by a weight sensor, coupled to the smart hook, during a first time period;
accessing a first geospatial location of the smart hook during loading of an object onto the smart hook during the first time period;
deriving a lifting profile of the object at the first geospatial location from the first timeseries of load values;
deriving a weight of the object from the first timeseries of load values;
identifying a type of the object carried by the smart hook during the first time period based on the lifting profile;
accessing a second geospatial location of the smart hook during unloading of the object from the smart hook; and
wherein correlating the first lift event with the first construction task comprises correlating the first lift event with the first construction task based on the weight of the object, the type of the object, and the drop-off location at the second geospatial location.

14. The method of claim 13, wherein correlating the first lift event with the first construction task comprises:
selecting the first construction task defining delivery of a target object type within a target weight range to a georeferenced boundary within the construction site;
calculating a weight score based on alignment between the weight of the object and the target weight range;
calculating an object score based on alignment between the type of the object and the target object type;
calculating a location score based on alignment between the drop-off location and the georeferenced boundary;
calculating a composite score based on a combination of the weight score, the object score, and the location score; and
associating the first lift event with the first construction task in response to the composite score exceeding a threshold score.

15. The method of claim 1:
wherein accessing the first set of load characteristics comprises:
accessing a first timeseries of load values output by a weight sensor, coupled to the smart hook, during a first time period;
accessing a first timeseries of motion values output by a motion sensor coupled to the smart hook;
accessing a first geospatial location of the smart hook during the first time period;
deriving a lifting profile from the first timeseries of load values;
deriving a first oscillation characteristic from the first timeseries of motion values;
identifying a type of an object, carried by the smart hook during the first time period, based on the lifting profile and the first oscillation characteristic;
accessing a second geospatial location of the smart hook during unloading of the object from the smart hook; and
wherein correlating the first lift event with the first construction task comprises correlating the first lift event with the first construction task based on the weight of the object, the type of the object, and the drop-off location at the second geospatial location.

16. The method of claim 15:
wherein deriving the first oscillation characteristic from the first timeseries of motion values comprises:
deriving a pitch frequency of the object from the first timeseries of motion values; and
deriving a natural frequency of the object from the first timeseries of motion values; and
wherein identifying the type of the object comprises:
calculating a set of pitch frequency similarity scores for the object, each pitch frequency similarity score in the set of pitch frequency similarity scores representing proximity of the pitch frequency of the object to a pitch frequency range of an object type in a set of object types;
calculating a set of natural frequency similarity scores for the object, each natural frequency similarity score in the set of natural frequency similarity scores representing proximity of the natural frequency of the object to a natural frequency range of an object type in the set of object types; and
identifying the object as a unit of a first object type based on a combination of the set of pitch frequency similarity scores and the set of natural frequency similarity scores.

17. The method of claim 1:
wherein accessing the first set of load characteristics comprises accessing:
a set of confidence scores for types of an object carried by the smart hook during the first lift event;
a weight of the object; and
a time of the first lift event; and
wherein correlating the first lift event with the first construction task comprises:
identifying a subset of incomplete construction tasks in the sequence of construction tasks;
for each construction task in the subset of incomplete construction tasks, calculating a similarity score between the first lift event and the construction task:
proportional to a confidence score, in the set of confidence scores, for an object type specified in the construction task;
inversely proportional to a difference between the weight of the object and a material weight specified in the construction task;
proportional to a spatial proximity of the drop-off location to a material staging location specified in the construction task; and
proportional to a temporal proximity of the time of the first lift event to a scheduled start time of the construction task; and
correlating the first lift event with the first construction task, in the subset of incomplete construction tasks, in response to a first similarity score of the first construction task exceeding a threshold similarity score.

18. The method of claim 1:
further comprising accessing a building schedule for the construction site;
wherein compiling the building model and the construction site plan into spatial and temporal representations of the sequence of construction tasks comprises, from the building model, the construction site plan, and the building schedule, for each construction task in the sequence of construction tasks:
extracting a material type for the construction task;
extracting a material quantity of the material type for the construction task;
extracting an unrigging geolocation on the construction site for the material type during the construction task; and
deriving a link to a preceding construction task requiring completion prior to the construction task;
wherein accessing the first set of load characteristics comprises accessing a first object type and a first object weight detected by the smart hook during the first lift event; and
wherein correlating the first lift event with the first construction task comprises correlating the first lift event with the first construction task based on:
alignment between the first object type and a first material type for the first construction task;
alignment between the first object weight and a first material quantity for the first construction task;
alignment between the drop-off location and a first unrigging geolocation of the first construction task; and
completion of a second construction task prior to the first lift event, the first construction task comprising a first link requiring completion of the second construction task prior to the first construction task.

19. The method of claim 1:
wherein accessing the building model comprises accessing the building model comprising a set of discrete volumetric representations of concrete elements, structural steel elements, glazing elements, and ventilation elements of a building on the construction site;
wherein accessing the construction site plan comprises accessing the construction site plan defining georeferenced locations for the building and material staging areas within the construction site;
further comprising:
accessing a building schedule specifying the sequence of construction tasks at the construction site; and
extracting the sequence of construction tasks from the building schedule;
wherein compiling the building model and the construction site plan into spatial and temporal representations of the sequence of construction tasks comprises, for each construction task in the sequence of construction tasks:
extracting a material type from the construction task;
linking the construction task to a discrete volumetric representation in the building model based on the material type and an order of the construction task in the sequence of construction tasks;
estimating a material quantity of the material type for the construction task based on a size of the discrete volumetric representation;
estimating an unrigging geolocation of the material type for the construction task based on a position of the discrete volumetric representation in the building model, a location of the building in the construction site plan, and material staging areas defined in the construction site plan; and
storing the material type, the material quantity, and the unrigging location in a construction task object for the construction task;
wherein accessing the first set of load characteristics comprises accessing a first object type and a first object weight detected by the smart hook during the first lift event; and
wherein correlating the first lift event with the first construction task comprises correlating the first lift event with the first construction task based on:
alignment between the first object type and a first material type specified in a first construction task object for the first construction task;
alignment between the first object weight and a first material quantity specified in the first construction task object; and
alignment between the drop-off location and a first unrigging geolocation specified in the first construction task object.

20. A method for monitoring processes and progress at a construction site comprising:
accessing spatial and temporal representations of a sequence of construction tasks planned on the construction site;
accessing a first set of load characteristics derived from data captured by a smart hook, arranged on a crane operated at the construction site, and a geospatial location of the smart hook during a first lift event at the crane;
correlating the first lift event with a first construction task, in the sequence of construction tasks, based on the first set of load characteristics and the drop-off location;
identifying a first notification trigger, in a set of notification triggers linked to the sequence of construction tasks, assigned to the first construction task; and
transmitting a first notification to a computing device, associated with a user, according to the first notification trigger, the first notification identifying the first construction task.
